(19) United States
(12) Patent Application Publication
(10) Pub. No.: US 2006/0192857 A1
(43) Pub. Date: Aug. 31, 2006

(54) Image processing device, image processing method, and program

(75) Inventors: Tetsujiro Kondo, Tokyo (JP); Masanori Kanemaru, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/552,467

(22) PCT Filed: Feb. 10, 2005
(86) PCT No.: PCT/JP05/02503

§ 371 Date: Oct. 7, 2005

(30) Foreign Application Priority Data
Feb. 13, 2004 (JP) 2004-037247

(51) Int. Cl. H04N 5/228

(52) U.S. Cl. 348/208.4

(57) ABSTRACT

Motion blurring of a moving object in an image is mitigated with tracking the moving object. A motion vector detection section 30 detects motion vector of the moving object moving in an image, which is made up of multiple pixels and acquired by an image sensor having time integration effects, by using image data Dva of the image. A motion-blurring-mitigated object image generation section 40 generates image data DBf of a motion-blurring-mitigated object image in which motion blurring occurred in the moving object in the image is mitigated by using the detected motion vector. A output section 50 combines the image data DBf of the motion-blurring-mitigated object image into a space-time location corresponding to the motion vector detected in the image based on background component image data DBb, to generate image data DVout of the motion-blurring-mitigated image.

### TECHNICAL FIELD

The present invention relates to an apparatus, a method, and a program for processing an image. More specifically, they detect a motion vector of a moving object in an image, which is made up of multiple pixels and acquired by an image sensor having time integration effects. By using this motion vector, motion blurring that occurs in the moving object in the image is mitigated so that a motion-blurring-mitigated object image can be generated, thereby combining the motion-blurring-mitigated object image that is generated during a motion-blurring-mitigated-object-image-generating step into a space-time location corresponding to the motion vector detected by the motion vector detection to output it as a motion-blurring-mitigated image.

### BACKGROUND ART

Data processing on events in actual world using a sensor has been conventionally performed. The data obtained by using the sensor is information obtained by projecting information in the actual world into a space-time that has a dimension lower than that of the actual world. Therefore, the information obtained by the projection has distortion generated due to the projection. For example, when data processing as image signal is performed by shooting a moving object before a still background with a video camera, the information in the actual world is sampled and processed to data, so that motion blurring that the moving object blurs can occur in an image displayed based on the image signal as the distortion generated due to the projection.

Thus, as disclosed in Japanese Patent Publication Application No. 2001-250119, for example, by detecting an outer edge of an image object corresponding to a foreground object included in an input image, the image object corresponding to the foreground object can be roughly extracted, so that a motion vector of the image object corresponding to the foreground object thus roughly extracted can be calculated, thereby allowing for mitigation of the motion blurring by using the calculated motion vector and positional information of the motion vector.

In Japanese Patent Publication Application No. 2001-250119, however, it tracks the moving object in the image for every image (frame) while it has not disclosed how to mitigate the motion blurring of the moving object.

### DISCLOSURE OF THE INVENTION

In view of the above, to mitigate motion blurring of a moving object in an image and output it while tracking the moving object in the image, an apparatus for processing an image related to the present invention comprises: motion vector detection means for detecting a motion vector about a moving object that moves in multiple images, each of which is made up of multiple pixels and acquired by an image sensor having time integration effects, and tracking the moving object; motion-blurring-mitigated object image generation means for generating a motion-blurring-mitigated object image in which motion blurring occurred in the moving object in each image of the multiple images is mitigated by using the motion vector detected by the motion vector detection means; and output means for combining the motion-blurring-mitigated object image that is generated in the motion-blurring-mitigated object image generation means into a space-time location, in each image, corresponding to the motion vector, said motion vector being detected by the motion vector detection means, to output it as a motion-blurring-mitigated image.

A method for processing an image related to the present invention comprises: motion-vector-detecting step of detecting a motion vector about a moving object that moves in multiple images, each of which is made up of multiple pixels and acquired by an image sensor having time integration effects, and tracking the moving object; motion-blurring-mitigated-object-image-generating step of generating a motion-blurring-mitigated object image in which motion blurring occurred in the moving object in each image of the multiple images is mitigated by using the motion vector detected in the motion-vector-detecting step; and output step of combining the motion-blurring-mitigated object image that is generated in the motion-blurring-mitigated-object-image-generating step into a space-time location, in each image, corresponding to the motion vector, said motion vector being detected in the motion-vector-detecting step, to output it as a motion-blurring-mitigated image.

A program related to the present invention allows a computer to perform: motion-vector-detecting step of detecting a motion vector about a moving object that moves in multiple images, each of which is made up of multiple pixels and acquired by an image sensor having time integration effects, and tracking the moving object; motion-blurring-mitigated-object-image-generating step of generating a motion-blurring-mitigated object image in which motion blurring occurred in the moving object in each image of the multiple images is mitigated by using the motion vector detected in the motion-vector-detecting step; and output step of combining the motion-blurring-mitigated object image that is generated in the motion-blurring-mitigated-object-image-generating step into a space-time location, in each image, corresponding to the motion vector, said motion vector being detected in the motion-vector-detecting step, to output it as a motion-blurring-mitigated image.

In the present invention, a target pixel corresponding to a location of the moving object in any one of at least a first image and a second image, which are sequential in terms of time, is set on a moving object that moves in multiple images, each of which is made up of multiple pixels and acquired by an image sensor having time integration effects; a motion vector corresponding to the target pixel is detected by using the first and second images; and a pixel value in which motion blurring of the target pixel is mitigated is obtained by using the detected motion vector, thereby generating the motion-blurring-mitigated image. The motion-blurring-mitigated image is output to a spatial location of the target pixel or corresponding to the motion vector.

In generation of this motion-blurring-mitigated image, in a processing region provided in the image, a pixel value of pixel of moving object is processed to turn into a model so that a pixel value of each pixel in which no motion blurring corresponding to the moving object occur becomes a value obtained by integrating the pixel value in a time direction with the pixel being moved. For example, in the processing region, the foreground region composed of only a foreground object component constituting a foreground object which is moving object, the background region composed of only a background object component constituting a background object, and the mixed region in which the foreground object component and the background object component are mixed are respectively identified; a mixture ratio of the foreground object component and the background object component in the mixed region is detected; at least a part of region of the image is separated into the foreground object and the background object, based on the mixture ratio; and motion blurring of the foreground object thus separated is mitigated based on the motion vector of the moving object. Alternatively, the motion vector is detected every pixel in the image; and the processing region is set as the foreground object region in which motion blurring occurs to use the detected motion vector for the target pixel in the processing region, thereby outputting pixel value in which motion blurring in the processing region is mitigated in pixel units. Further, an expanded image is generated on the basis of the moving object due to the motion-blurring-mitigated image.

According to the present invention, a motion vector is detected on the moving object that moves in multiple images, each of which is made up of multiple pixels and acquired by an image sensor having time integration effects and by using the detected motion vector, motion blurring occurred in the moving object in each image of the multiple images is mitigated. This motion-blurring-mitigated object image in which motion blurring is mitigated is combined into a time-space location in each image corresponding to the detected motion vector, thereby outputting it as the motion-blurring-mitigated image. This allows motion blurring of the moving object to be mitigated every frame while tracking the moving object.

The target pixel corresponding to a location of the moving object in any one of at least a first image and a second image, which are sequential in terms of time, is set; the motion vector corresponding to the target pixel is detected by using the first and second images; and the motion-blurring-mitigated image is combined into a position of the target pixel in the set image or a location, which corresponds to the target pixel, in the other image, the locations corresponding to the detected motion vector. This allows the motion-blurring-mitigated object image to be output to its proper position.

In a processing region in the image, a pixel value of pixel of moving object is turned into a model so that pixel value of each pixel in which no motion blurring corresponding to the moving object occur becomes a value obtained by integrating the pixel value in a time direction with the pixel being moved, and based on the pixel value of the pixel in the processing region, the motion-blurring-mitigated object image in which motion blurring of the moving object included in the processing region is mitigated can be generated. This allows any buried significant information to be extracted, thereby mitigating motion blurring.

In this mitigation of the motion blurring, in the processing region, the foreground region composed of only a foreground object component constituting a foreground object which is moving object, the background region composed of only a background object component constituting a background object, and the mixed region in which the foreground object component and the background object component are mixed are identified, and based on the mixture ratio of the foreground object component and the background object component in the mixed region, at least a part of region of the image is separated into the foreground object and the background object, thereby allowing the motion blurring of the foreground object thus separated to be mitigated based on the motion vector. This allows component of the moving object to be separated based on the extracted mixture ration as the significant information, so that the motion blurring can be accurately mitigated on the basis of the component of the separated moving object.

Alternatively, the motion vector is detected every pixel in the image and the processing region is set so that the target pixel can be included therein according to the motion vector of the target pixel in the image, thereby outputting pixel value in which motion blurring in the target pixel is mitigated in pixel units based on the motion vector of the target pixel. This allows motion blurring of the moving object to be mitigated even if a motion of the moving object is different in every pixel.

Further, a class tap corresponding to a target pixel in the expanded image is extracted from the motion-blurring-mitigated image so that a class is determined based on a pixel value of the class tap. Predictive tap corresponding to the target pixel is extracted from the motion-blurring-mitigated image, so that a predictive value corresponding to the target pixel can be generated according to one-dimensional linear combination of the predictive coefficient corresponding to the determined class and the predictive tap. This allows a high-definition expanded image in which motion blurring is mitigated to be generated using the motion-blurring-mitigated image. Generation of the expanded image is performed on the basis of the moving object so that the expanded image of the moving object can be output while tracking the moving object.

### BRIEF DESCRIPTION OF THE DRAWINGS

FIG. 1 is a block diagram of a configuration of a system to which the present invention is applied;

FIG. 2 is a diagram for illustrating image shooting by an image sensor;

FIGS. 3A and 3B are explanatory diagrams of a shot image;

FIG. 4 is an explanatory diagram of time-directional division operation of pixel values;

FIG. 5 is a block diagram for showing a configuration of an apparatus for processing an image;

FIG. 6 is a block diagram for showing a configuration of a motion vector detection section;

FIG. 7 is a block diagram for showing a configuration of a motion-blurring-mitigated object image generation section;

FIG. 8 is a block diagram for showing a configuration of a region identification section;

FIG. 9 is a diagram for showing image data read from an image memory;

FIG. 10 is a diagram for showing region decision processing;

FIG. 11 is a block diagram for showing a configuration of a mixture ratio calculation section;

FIG. 12 is a diagram for showing an ideal mixture ratio;

FIG. 13 is a block diagram for showing a configuration of a foreground/background separation section;

FIG. 14 is a block diagram for showing a configuration of a motion blurring adjustment section;

FIG. 15 is a diagram for showing adjustment processing units;

FIG. 16 is a diagram for showing a position of a pixel value in which motion blurring is mitigated;

FIG. 17 is a diagram for showing another configuration of the apparatus for processing the image;

FIG. 18 is a flowchart for showing operations for showing the apparatus for processing the image;

FIG. 19 is a flowchart for showing generation processing of the motion-blurring-mitigated object image;

FIG. 20 is a block diagram for showing a configuration of another motion-blurring-mitigated image generation section;

FIG. 21 is a diagram for showing a processing region;

FIGS. 22A and 22B are diagrams each showing an example of setting up a processing region;

FIG. 23 is an explanatory diagram of time-wise mixture of actual world variables in a processing region;

FIGS. 24A-24C are diagrams each showing an example where an object moves;

FIGS. 25A-25F are diagrams each showing an expanded display image with tracking the object;

FIG. 26 is a block diagram for showing a configuration of further apparatus for processing the image;

FIG. 27 is a block diagram for showing a configuration of a space resolution creation section;

FIG. 28 is a block diagram for showing a configuration of a learning device; and

FIG. 29 is a flowchart for showing an operation in a case where space resolution creation processing is combined.

### BEST MODE FOR CARRYING OUT THE INVENTION

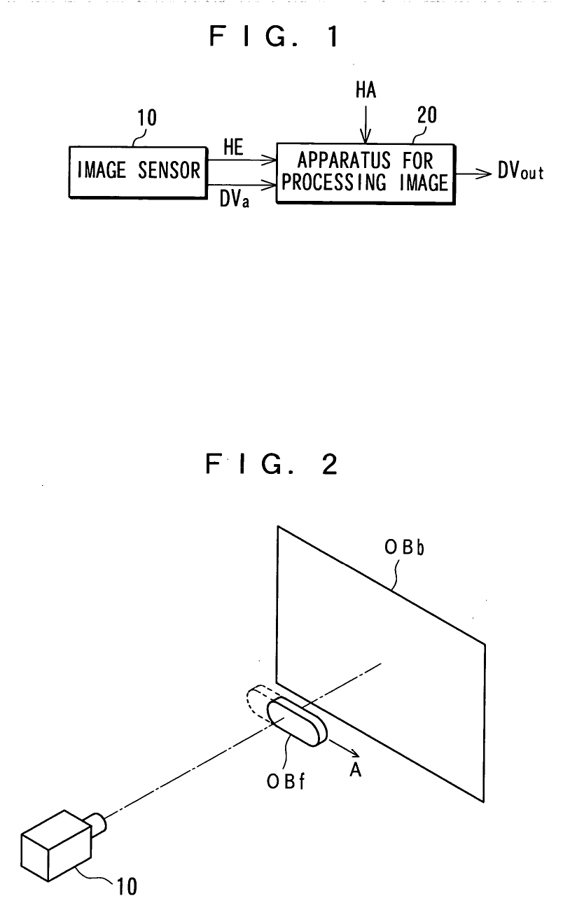

The following will describe one embodiment of the present invention with reference to drawings. FIG. 1 is a block diagram for showing a configuration of a system to which the present invention is applied. An image sensor 10 that is constituted of a video camera etc. equipped with a charge-coupled device (CCD) area sensor or a CMOS area sensor, which is a solid-state image sensing device, shoots a actual world. For example, when a moving object OBf that corresponds to a foreground moves in an arrow direction “A” between the image sensor 10 and an object OBb that corresponds to a background as shown in FIG. 2, the image sensor 10 shoots the object OBb that corresponds to the background as well as the moving object OBf that corresponds to the foreground.

This image sensor 10 is made up of a plurality of detection elements each of which has time integration effects and so integrates, for an exposure lapse of time, electrical charge generated in accordance with incoming light for each of the detection elements. That is, the image sensor 10 performs photoelectric transfer in converting the incoming light into the electrical charge, to accumulate it in units of, for example, one frame period. In accordance with a quantity of the accumulated electrical charge, it generates pixel data and then uses this pixel data to generate image data DVa having a desired frame rate and supplies the data to an apparatus 20 for processing an image. The image sensor 10 is further provided with shutter functions, so that if image data DVa is generated by adjusting an exposure lapse of time in accordance with a shutter speed, it supplies the apparatus 20 for processing the image with a parameter HE for exposure lapse of time, which is indicative of the exposure lapse of time. This parameter HE for exposure lapse of time indicates a shutter-open lapse of time in one frame period in value of, for example, “0” through “1.0”, which value is set to 1.0 when the shutter functions are not used and 0.5 when the shutter lapse of time is ½ of the frame period.

The apparatus 20 for processing the image extracts significant information buried in image data DVa owing to the time integration effects exerted at the image sensor 10 and utilizes this significant information to mitigate motion blurring due to the time integration effects generated on the moving object OBf that corresponds to the moving foreground. It is to be noted that the apparatus 20 for processing the image is supplied with region selection information HA for selecting an image region in which motion blurring is mitigated.

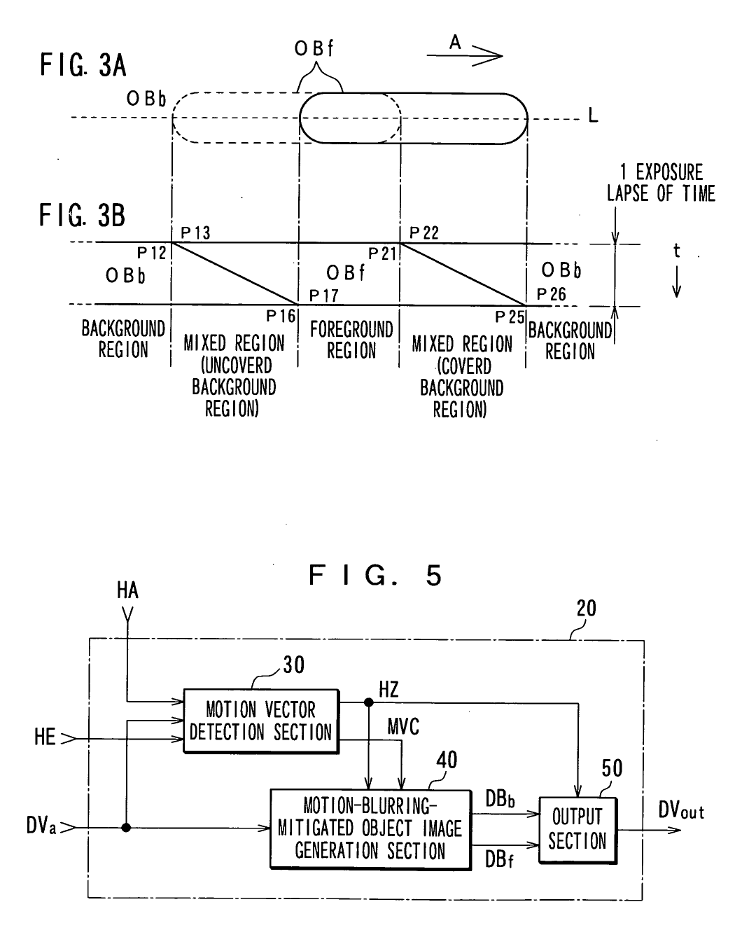

FIG. 3 are explanatory diagrams of a picked up image given by the image data DVa. FIG. 3A shows an image obtained by shooting the moving object OBf that corresponds to the moving foreground and the object OBb that corresponds to the background at rest. Here, it is supposed that the object OBf that corresponds to the foreground is moving horizontally in the arrow direction “A”.

FIG. 3B shows a relationship between the image and time along a line L indicated by a broken line of FIG. 3A. In a case where a length over which the moving object OBf moves along the line L is, for example, as much as nine pixels and it moves by as much as five pixels in one exposure lapse of time, a front end located at pixel location P21 and a rear end located at pixel location P13 when a frame period starts move to pixel locations P25 and P17, respectively, when the exposure lapse of time ends. Further, if the shutter functions are not in use, an exposure lapse of time in one frame equals one frame period, so that the front end and the rear end are located to pixel locations P26 and P18, respectively, when the next frame period starts. For simplicity of explanation, it is supposed that the shutter functions are not used unless otherwise specified.

Therefore, in a frame period along the line L, a portion thereof ahead of pixel location P12 and a portion thereof behind pixel location P26 constitute a background region comprised of only background component. Further, a portion thereof over pixel locations P17-P21 constitutes a foreground region comprised of only foreground component. A portion thereof over pixel locations P13-P16 and a portion thereof over pixel locations P22-P25 each constitute a mixed region where foreground component and background component are mixed. The mixed regions are classified into a covered background where background component is covered by a foreground as time passes by and an uncovered background region where the background component appears as time passes by. It is to be noted that, in FIG. 3B, a mixed region located on the side of a front end of a foreground object in a direction in which the foreground object goes is the covered background region and a mixed region located on the side of its rear end is the uncovered background region. Thus, the image data DVa contains an image that includes a foreground region, a background region, a covered background region, or an uncovered background region.

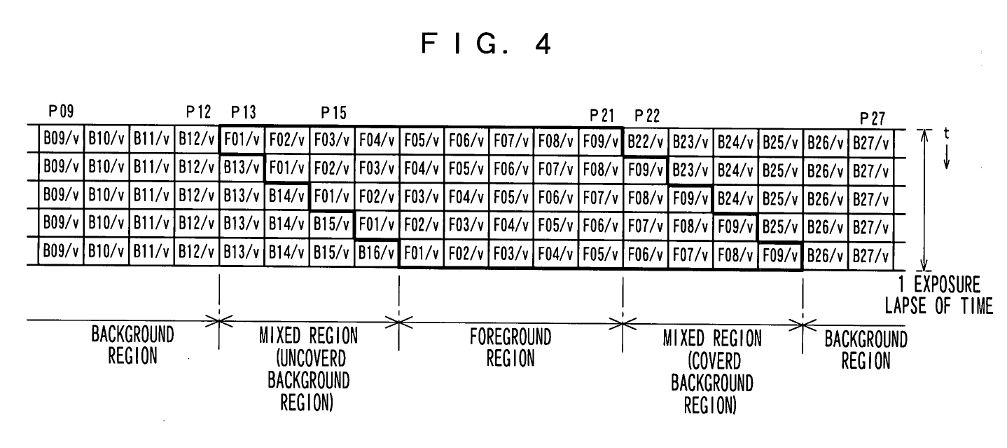

It is to be noted that one frame is short in time, so that on the assumption that the moving object OBf that corresponds to a foreground is rigid and moving at the same speed, a pixel value in one exposure lapse of time is subject to time-directional division, to be divided by a virtual division number to equal time intervals as shown in FIG. 4.

The virtual division number is set in accordance with a movement quantity v, in one frame period, of the moving object that corresponds to the foreground. For example, if the movement quantity v in one frame period is five pixels as described above, the virtual division number is set to “5” according to the movement quantity v to divide the one frame period into five equal time intervals.

Further, a pixel value, in one frame period, of pixel location Px obtained when the object OBb that corresponds to the background is shot is assumed to be Bx and pixel values obtained for pixels when the moving object OBf that corresponds to the foreground and has a length of as many as nine pixels along the line L is shot at rest are assumed to be F09 (on the front end side) through F01 (on the rear end side).

In this case, for example, pixel value DP15 of pixel location P15 is given by Equation 1:
DP15=B15/v+B15/v+F01/v+F02/v+F03/v (1)

This pixel location P15 contains a background component as much as two divided virtual lapses of time (frame period/v) and a foreground component as much as three divided virtual lapses of time, so that a mixture ratio α of the background component is 2/5. Similarly, for example, pixel location P22 contains the background component as much as one divided virtual lapse of time and the foreground component as much as four divided virtual lapses of time, so that the mixture ratio α is 1/5.

Since it is assumed that the moving object that corresponds to the foreground is rigid and moving at the same speed so that an image of the foreground may be displayed rightward as much as five pixels in the next frame, foreground component (F01/v), for example, of pixel location P13 in a first divided virtual lapse of time is the same as foreground component of pixel location P14 in a second divided virtual lapse of time, foreground component of pixel location P15 in a third divided virtual lapse of time, foreground component of pixel location P16 in a fourth divided virtual lapse of time, and foreground component of pixel location P17 in a fifth divided virtual lapse of time, respectively. Foreground component (F02/v) of pixel location P14 in a first divided virtual lapse of time through foreground component (F09/v) of pixel location P21 in a first divided virtual lapse of time are exactly alike a case of the foreground component (F01/v).

Therefore, it is possible to give pixel value DP of each pixel location by using a mixture ratio α as indicated in Equation 2. In Equation 2, “FE” represents a sum of foreground components.
DP=α·B+FE (2)

Since the foreground component thus moves, different foreground components are added to each other in one frame period, so that a foreground region that corresponds to a moving object contains motion blurring. Accordingly, the apparatus 20 for processing the image extracts the mixture ratio α as significant information buried in the image data DVa and utilizes this mixture ratio α, to generate image data DVout in which motion blurring of the moving object OBf that corresponds to the foreground is mitigated.

FIG. 5 is a block diagram of a configuration of the apparatus 20 for processing the image. Image data DVa supplied to the apparatus 20 is in turn provided to a motion vector detection section 30 and a motion-blurring-mitigated object image generation section 40. Further, region selection information HA and parameter HE for exposure lapse of time are supplied to the motion vector detection section 30. The motion vector detection section 30 detects a motion vector of moving object that moves in each of the multiple images, each of which is composed of multiple pixels and acquired by the image sensor 10 having time integration effects. Specifically, processing regions subject to motion blurring mitigation processing are sequentially extracted based on the region selection information HA, so that a motion vector MVC that corresponds to the moving object in the processing region can be detected and supplied to the motion-blurring-mitigated object image generation section 40. For example, it sets up a target pixel that corresponds to a position of a moving object in any one of at least first and second images that occur successively in time, to detect a motion vector that corresponds to this target pixel by using these first and second images. Further, it generates processing region information HZ indicative of the processing region and supplies the information to the motion-blurring-mitigated object image generation section 40 and an output section 50. In addition, it updates the region selection information HA in accordance with movement of the object in the foreground, to move the processing region as the moving object moves.

The motion-blurring-mitigated object image generation section 40 specifies a region or calculates a mixture ratio based on the motion vector MVC, the processing region information HZ, and the image data DVa and uses the calculated mixture ratio to separate foreground component and background component from each other. Furthermore, it performs a motion blurring adjustment on an image of the separated foreground component to generate a motion-blurring-mitigated object image. Further, foreground component image data DBf that is image data of the motion-blurring-mitigated object image acquired by this motion-blurring adjustment is supplied to the output section 50. Image data DBb of the separated background component is also supplied to the output section 50.

The output section 50 combines an image of foreground region in which motion blurring based on the foreground component image data DBf onto a background image based on the background component image data DBb, thereby generating image data DVout of the motion-blurring-mitigated image and outputting it. In this case, the foreground region image, which is the motion-blurring-mitigated object image, can be combined into a space-time position that corresponds to the detected motion vector MVC, to output a motion-blurring-mitigated object image of the moving object to a position that tracks the moving object. That is, when the motion vector is detected using at least first and second images that occur successively in time, a motion-blurring-mitigated object image of the moving object is combined into a position of a target pixel in an image or a position that corresponds to a target pixel in the other image, both positions of which correspond to this detected motion vector.

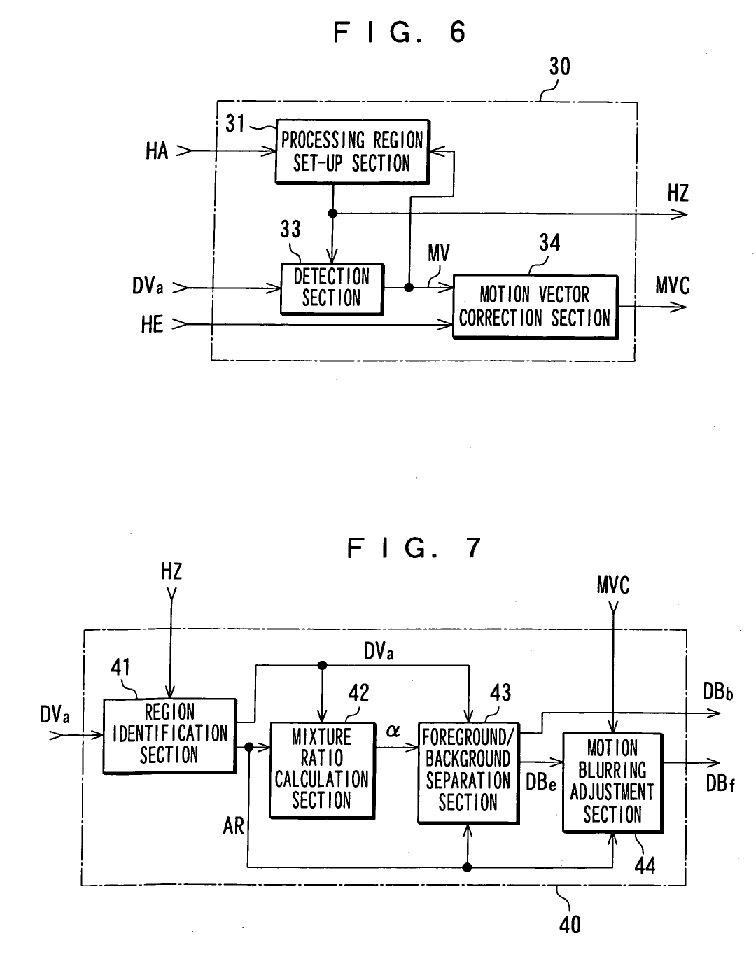

FIG. 6 is a block diagram for showing a configuration of the motion vector detection section 30. The region selection information HA is supplied to a processing region set-up section 31. Further, the image data DVa is supplied to a detection section 33 and the parameter HE for the exposure lapse of time is supplied to a motion vector correction section 34.

The processing region set-up section 31 sequentially extracts processing regions subject to motion-blurring mitigation processing based on the region selection information HA and supplies the detection section 33, the motion-blurring-mitigated object image generation section 40, and the output section 50 with processing region information HZ that indicates these processing regions. Further, it utilizes a motion vector MVO detected by the detection section 33, which will be described later, to update the region selection information HA, thereby causing a processing region subject to mitigation of motion blurring to be tracked in such a manner that it can be met to a movement of a motion object.

The detection section 33 uses, for example, the block matching method, the gradient method, the phase correlation method, the Pel-Recursive algorithm or the like to perform motion vector detection on the processing region indicated by the processing region information HZ and supply the detected motion vector MV to the moving vector correction section 34. Alternatively, the detection section 33 detects a periphery of a tracking point set up in the region indicated by the region selection information HA, for example, region(s) having the same image characteristic quantity as that in the region indicated by the region selection information HA from image data of a plurality of time-directional peripheral frames, thereby calculating the motion vector MV at the tracking point and supplying it to the processing region set-up section 31.

The motion vector MV output by the detection section 33 contains information that corresponds to a movement quantity (norm) and a movement direction (angle). The movement quantity refers to a value that represents a change in position of an image corresponding to the moving object. For example, if the moving object OBf that corresponds to a foreground has moved by as much as move-x horizontally and by as much as move-y vertically in a frame next to a certain reference frame, its movement quantity can be obtained by Equation 3. Its movement direction can be also obtained by Equation 4. Only one pair of the movement quantity and movement direction is given to a processing region.
Movement quantity=\sqrt{(move−x)²+(move−y)²} (3)
Movement direction=tan⁻¹(move−y/move−x) (4)

The motion vector correction section 34 corrects the motion vector MV using the parameter HE for the exposure lapse of time. The motion vector MV supplied to the motion vector correction section 34 is an inter-frame motion vector as described above. However, a motion vector to be used by the motion-blurring-mitigated object image 1D generation section 40, which will be described later, is processed using an intra-frame motion vector, so that if an inter-frame motion vector is used when an exposure lapse of time in one frame is shorter than one frame period because the shutter functions are used, motion-blurring-mitigated processing cannot be performed properly. Therefore, with the motion vector MV, which is an inter-frame motion vector, being corrected in the proportion of the exposure lapse of time to the one frame period of time, it is supplied to the motion-blurring-mitigated object image generation section 40 as a motion vector MVC.

FIG. 7 is a block diagram for showing a configuration of the motion-blurring-mitigated object image generation section 40. A region identification section 41 generates information (hereinafter referred to as “region information”) AR that indicates which one of a foreground region, a background region, and a mixed region each of the pixels in the processing region indicated by the processing region information HZ in the image displayed on the basis of the image data DVa belongs to and supplies it to a mixture ratio calculation section 42, a foreground/background separation section 43, and a motion blurring adjustment section.

The mixture ratio calculation section 42 calculates a mixture ratio α of a background component in the mixed region based on the image data DVa and the region information AR supplied from the region identification section 41 and supplies the calculated mixture ratio α to the foreground/background separation section 43.

The foreground/background separation section 43 separates the image data DVa into foreground component image data DBe comprised of only foreground component and background component image data DBb comprised of only background component based on the region information AR supplied from the region identification section 41 and the mixture ratio α supplied from the mixture ratio calculation section 42 and supplies the foreground component image data DBe to the motion blurring adjustment section 44.

The motion blurring adjustment section 44 decides an adjustment-processing unit indicative of at least one pixel contained in the foreground component image data DBe based on a movement quantity indicated by the motion vector MVC and the region information AR. The adjustment-processing unit is data that specifies one group of pixels subject to motion-blurring mitigation processing.

The motion blurring adjustment section 44 mitigates motion blurring contained in the foreground component image data DBe based on the foreground component image supplied from the foreground/background separation section 43, the motion vector MVC supplied from the motion vector detection section 30 and its region information AR, and the adjustment-processing unit. It supplies this motion-blurring-mitigated foreground component image data DBf to the output section 50.

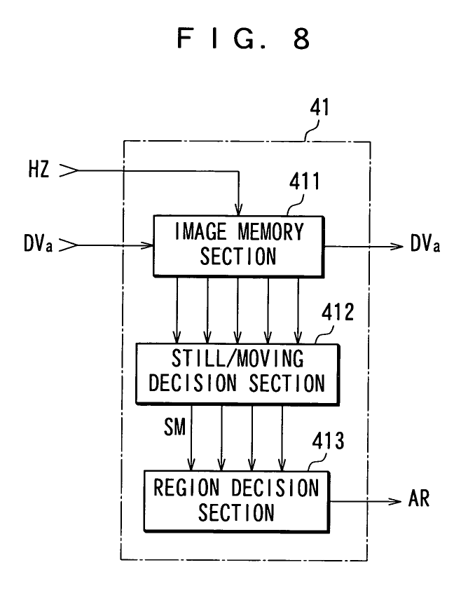

FIG. 8 is a block diagram for showing a configuration of the region identification section 41. An image memory 411 stores the input image data DVa in frame units. If frame #n is to be processed, the image memory 411 stores frame #n−2 which occurs two frames, in time, before the frame #n, frame #n−1 which occurs one frame before the frame #n, frame #n, frame #n+1 which occurs one frame after the frame #n, and frame #n+2 which occurs two frame after the frame #n.

A still/moving decision section 412 reads from the image memory 411 image data of frames #n−2, #n−1, #n+1, and #n+2 in the same region 1D as that specified by the processing region information HZ for frame #n and calculates an inter-frame absolute difference value between items of the read image data. It decides which of a moving portion or a still portion according to whether this inter-frame absolute difference value is higher than a preset threshold value Th and supplies a region decision section 413 with still/moving decision information SM that indicates a result of this decision.

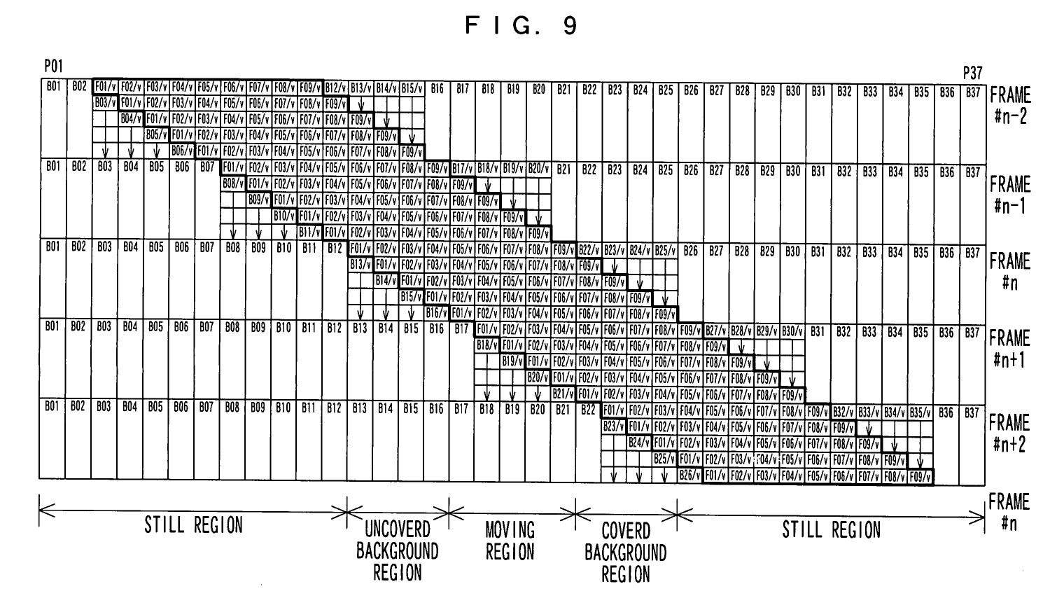

FIG. 9 shows the image data read from the image memory 411. It is to be noted that FIG. 9 shows a case where image data of pixel locations P01-P37 along one line in a region identified by the processing region information HZ is read.

The still/moving decision section 412 obtains an inter-frame absolute difference value for each of the pixels of two consecutive frames, decides whether the inter-frame absolute difference value is higher than a preset threshold value Th, and decides that it is “moving” if the inter-frame absolute difference value is higher than the threshold value Th or that it is “still”, if not higher than the threshold value Th.

The region decision section 413 performs region decision processing shown in FIG. 10, by using a result of decision obtained at the still/moving decision section 412, to decide which one of a still region, a covered background region, an uncovered background region, and a moving region each pixel of a region identified by the processing region information HZ belongs to.

For example, first it decides such a pixel as to have been decided to be still as a result of still/moving decision on frames #n−1 and #n to be of a pixel of the still region. Further, it also decides such a pixel as to have been decided to be still as a result of still/moving decision on frames #n and #n+1 to be of a pixel of the still region.

Next, it decides such a pixel as to have been decided to be still as a result of still/moving decision on frames #n−2 and #n−1 but to be moving as a result of still/moving decision on frames #n−1 and #n to be of a pixel of the covered background region. Further, it decides such a pixel as to have been decided to be moving as a result of still/moving decision on frames #n and #n+1 but to be still as a result of still/moving decision on frames #n+1 and #n+2 to be of a pixel of the uncovered background region.

Then, it decides such a pixel as to have been decided to be moving as a result of both still/moving decision on frames #n−1 and #n and still/moving decision on frames #n and #n+1 to be of a pixel of the moving region.

It is to be noted that there may be some cases where a pixel which exists on the side of a moving region in a covered background region or on the side of the moving region in an uncovered background region is decided to be of the covered background region or the uncovered background region respectively even if no background components are contained in it. For example, pixel location P21 in FIG. 9 is decided to be still as a result of still/moving decision on frames #n−2 and #n−1 but to be moving as a result of still/moving decision on frames #n−1 and #n and so may be decided to be of the covered background region even if no background components are contained in it. Another pixel location P17 is decided to be moving as a result of still/moving decision on frames #n and #n+1 but to be still as a result of still/moving decision on frames #n+1 and #n+2 and so may be decided to be of the uncovered background region even if no background components are contained in it. Therefore, correcting each of the pixels on the side of a moving region in a covered background region and each of the pixels on the side of a moving region in an uncovered background region into a pixel of a movement quantity region allows region decision on each pixel to be accurately performed. By thus performing region decision, region information AR that indicates which one of a still region, a covered background region, an uncovered background region, and a moving region each pixel belongs to is generated and supplied to the mixture ratio calculation section 42, the foreground/background separation section 43, and the motion blurring adjustment section 44.

It is to be noted that the region identification section 41 could take a logical sum of region information of an uncovered background region and that of a covered background region to thereby generate region information of a mixed region so that region information AR may indicate which one of the still region, the mixed region, and the moving region each of the pixels belongs to.

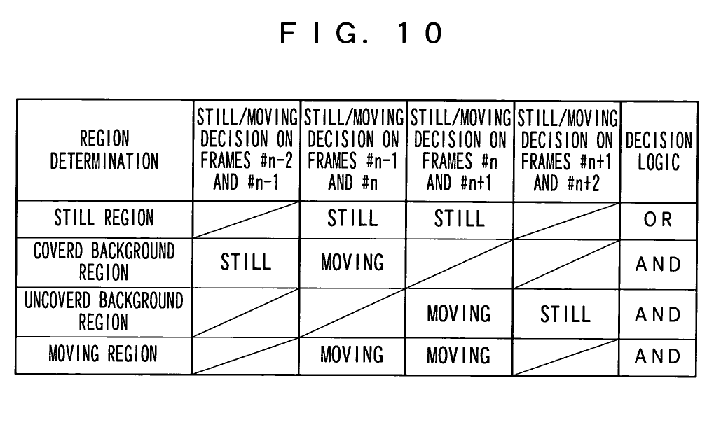

FIG. 11 is a block diagram for showing a configuration of the mixture ratio calculation section 42. An estimated-mixture-ratio-processing section 421 calculates an estimated mixture ratio αc for each pixel by performing operations for a covered background region based on image data DVa and supplies this calculated estimated mixture ratio αc to a mixture ratio determination section 423. Another estimated-mixture-ratio-processing section 422 calculates an estimated mixture ratio αu for each pixel by performing operations for an uncovered background region based on the image data DVa and supplies this calculated estimated mixture ratio αu to the mixture ratio determination section 423.

The mixture ratio determination section 423 sets a mixture ratio α of background component based on the mixture ratios αc and αu supplied from the estimated-mixture-ratio-processing sections 421, 422, respectively, and the region information AR supplied from the region identification section 41. The mixture ratio determination section 423 sets the mixture ratio α to 0 (α=0) if a target pixel belongs to a moving region. If the target pixel belongs to a still region, on the other hand, it sets the mixture ratio α to 1 (α=1). If the target pixel belongs to a covered background region, it sets the estimated mixture ratio αc supplied from the estimated-mixture-ratio-processing section 421, to the mixture ratio α; and if the target pixel belongs to an uncovered background region, it sets the estimated mixture ratio au supplied from the estimated-mixture-ratio-processing section 422, to the mixture ratio α. The mixture ratio α thus set is supplied to the foreground/background separation section 43.

If, here, a frame period is short and so it may be assumed that a moving object that corresponds to a foreground is rigid and moving at the same speed in this frame period, a mixture ratio α of a pixel that belongs to a mixed region changes linearly in accordance with a change in position of the pixel. In such a case, a gradient θ of the ideal mixture ratio α in the mixed region can be expressed as an inverse number of a movement quantity v in a frame period of the moving object that corresponds to the foreground as shown in FIG. 12. That is, the mixture ratio α has a value of “1” in the still region and a value of “0” in the moving region and changes in a range of “0” through “1” in the mixed region.

Pixel value DP24 of pixel location P24 in a covered background region shown in FIG. 9 can be given by the following equation 5 on the assumption that a pixel value of pixel location P24 in frame #n−1 is B24:

$$\begin{matrix}DP 24 = 3 B 24 / v + F 08 / v + F 09 / v \\ = 3 / v \cdot B 24 + {\sum }_{i = 08}^{09} Fi / v\end{matrix} \qquad ( 5 )$$

This pixel value DP24 contains background component by 3/v, so that the mixture ratio α when the movement quantity v is “5” (v=5) is 3/5 (α=3/5).

That is, pixel value Dgc of pixel location Pg in the covered background region can be given by the following equation 6. It is to be noted that “Bg” represents a pixel value of pixel location Pg in frame #n−1 and “FEg” represents a sum of foreground components at pixel location Pg.
Dgc=αc·Bg+FEg (6)

Further, if it is assumed that a pixel value in frame #n+1 at a pixel location having pixel value Dgc is assumed to be Fg and values of Fg/v at this pixel location are all the same as each other, FEg=(1−αc)Fg. That is, Equation 6 can be changed into the following equation 7:
Dgc=αc·Bg+(1−αc)Fg (7)

This equation 7 can be changed into the following equation 8:
αc=(Dgc−Fg)/(Bg−Fg) (8)

In Equation 8, Dgc, Bg, and Fg are known, so that the estimated-mixture-ratio-processing section 421 can obtain an estimated mixture ratio αc of a pixel in the covered background region by using pixel values of frames #n−1, #n, and #n+1.

As for uncovered background regions also, like the case of a covered background region, if a pixel value in the uncovered background region is assumed to be DPu, the following equation 9 can be obtained:
αu=(Dgu−Bg)/(Fg−Bg) (9)

In Equation 9, Dgu, Bg, and Fg are known, so that the estimated-mixture-ratio-processing section 422 can obtain an estimated mixture ratio αu of a pixel in the uncovered background region by using pixel values of frames #n−1, #n, and #n+1.

The mixture ratio determination section 423 sets the mixture ratio α to 1 (α=1) if the region information AR indicates a still region and sets the ratio to 0 (α=0) if it indicates a moving region and outputs the ratio. Further, if it indicates a covered background region or an uncovered background region, it outputs as the mixture ratio α an estimated mixture ratio αc calculated by the estimated-mixture-ratio-processing section 421 or an estimated mixture ratio αu calculated by the estimated-mixture-ratio-processing section 422, respectively.

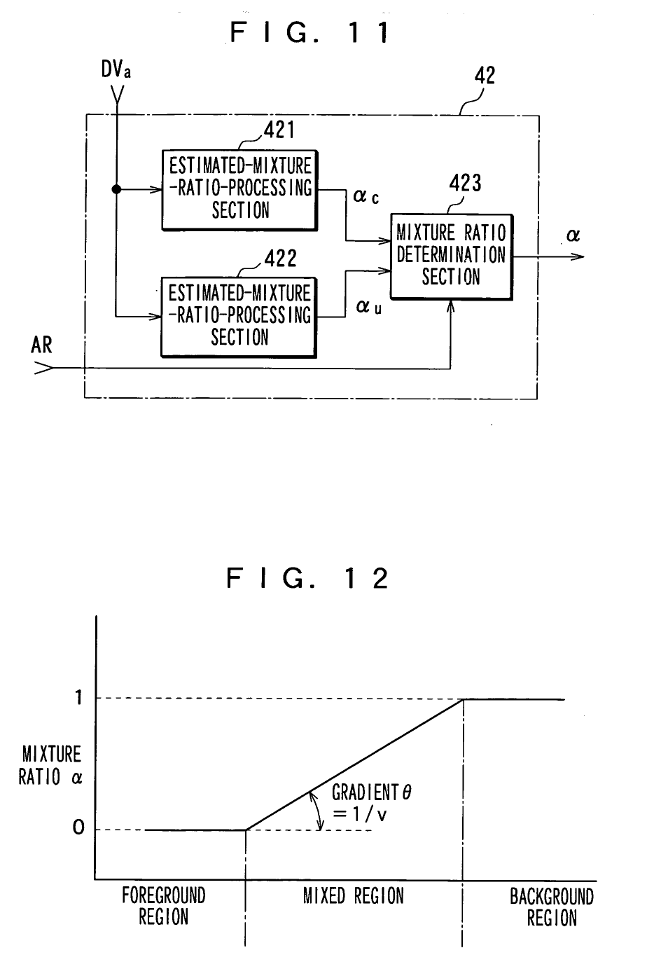

FIG. 13 is a block diagram for showing a configuration of the foreground/background separation section 43. The image data DVa supplied to the foreground/background separation section 43 and the region information AR supplied from the region identification section 41 are provided to a separation section 431, a switch section 432, and another switch section 433. The mixture ratio α supplied from the mixture ratio calculation section 42 is supplied to the separation section 431.

Based on the region information AR, the separation section 431 separates from the image data DVa data of pixels in a covered background region and an uncovered background region. Based on this separated data and the mixture ratio α, it separates component of a foreground object that has generated a movement and component of a background at rest from each other, to supply foreground component, which is the component of foreground object, to a synthesis section 434 and the background component to another synthesis section 435.

For example, in frame #n of FIG. 9, pixel locations P22-P25 belong to a covered background region, and if these pixel locations P22-P25 have mixture ratios α22-α25 respectively, pixel value DP22 of pixel location P22 can be given by the following equation 10 on the assumption that a pixel value of pixel location P22 in frame #n−1 is “B22j”:

$$\begin{matrix}DP 22 = B 22 / v + F 06 / v + F 07 / v + F 08 / v + F 09 / v \\ = α 22 \cdot B 22 j + F 06 / v + F 07 / v + F 08 / v + F 09 / v\end{matrix} \qquad ( 10 )$$

Foreground component FE22 of pixel location P22 in this frame #n can be given by the following equation 11:

$$\begin{matrix}FE 22 = F 06 / v + F 07 / v + F 08 / v + F 09 / v \\ = DP 22 - α 22 \cdot B 22 j\end{matrix} \qquad ( 11 )$$

That is, foreground component FEgc of pixel location Pg in a covered background region in frame #n can be obtained using the following equation 12 if a pixel value of pixel location Pg in frame #n−1 is assumed to be “Bgj”:
FEgc=DPg−αc·Bgj (12)

Further, foreground component FEgu in an uncovered background region can also be obtained as in the case of foreground component FEgc in the covered background region.

For example, in frame #n, pixel value DP16 of pixel location P16 in an uncovered background region is given by the following equation 13 if a pixel value of pixel location P16 in frame #n+1 is assumed to be “B16k”:

$$\begin{matrix}DP 16 = B 16 / v + F 01 / v + F 02 / v + F 03 / v + F 04 / v \\ = α 16 \cdot B 16 k + F 01 / v + F 02 / v + F 03 / v + F 04 / v\end{matrix} \qquad ( 13 )$$

Foreground component FE16 of the pixel location P16 in this frame #n can be given by the following equation 14:

$$\begin{matrix}FE 16 = F 01 / v + F 02 / v + F 03 / v + F 04 / v \\ = DP 16 - α 16 \cdot B 16 k\end{matrix} \qquad ( 14 )$$

That is, the foreground component FEgu of pixel location Pgu in an uncovered background region in frame #n can be obtained by using the following equation 15 if a pixel value of pixel location Pg in frame #n+1 is assumed to be “Bgk”:
FEgu=DPg−αu·Bk (15)

The separation section 431 can thus separate the foreground component and the background component from each other by using the image data DVa, region information AR generated by the region identification section 41, and the mixture ratio α calculated by the mixture ratio calculation section.

The switch section 432 conducts switch control based on the region information AR to thereby select data of a pixel in a moving region from the image data DVa and supply it to the synthesis section 434. The switch section 433 conducts switch control based on the region information AR to thereby select data of a pixel in a still region from the image data DVa and supply it to the synthesis section 435.

The synthesis section 434 synthesizes the foreground component image data DBe by using the component of the foreground object supplied from the separation section 431 and the data of the moving region supplied from the switch section 432 and supplies it to the motion blurring adjustment section 44. Further, in initialization which is performed first in processing to generate the foreground component image data DBe, the synthesis section 434 stores, in a built-in frame memory, initial data whose pixel values are all 0 and overwrites image data on this initial data. Therefore, a portion that corresponds to the background region will be a state of the initial data.

The synthesis section 435 synthesizes the background component image data DBb by using the background component supplied from the separation section 431 and the data of the still region supplied from the switch section 433 and supplies it to the output section 45. Further, in initialization which is performed first in processing to generate the background component image data DBb, the synthesis section 435 stores, in the built-in frame memory, an image whose pixel values are all 0 and overwrites image data on this initial data. Therefore, a portion that corresponds to the foreground region will be a state of the initial data.

FIG. 14 is a block diagram for showing a configuration of the motion blurring adjustment section 44. A motion vector MVC supplied from the motion vector detection section 30 is provided to an adjustment-processing unit determination section 441 and a modeling section 442. Region information AR supplied from the region identification section 41 is supplied to the adjustment-processing unit determination section 441. Foreground component image data DBe supplied from the foreground/background separation section 43 is supplied to a supplementation section 444.

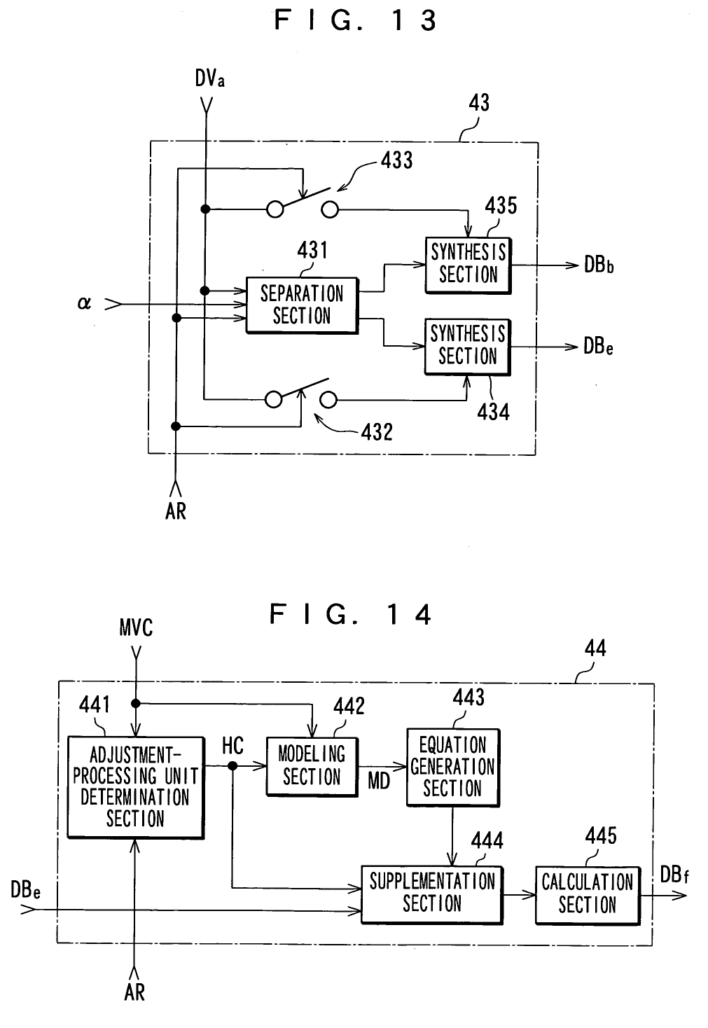

The adjustment-processing unit determination section 441 sets up, as an adjustment-processing unit, consecutive pixels that are lined up in a movement direction from the covered background region toward the uncovered background region in the foreground component image, based on the region information AR and the motion vector MVC. Alternatively, it sets up, as an adjustment-processing unit, consecutive pixels that are lined up in a movement direction from the uncovered background region toward the covered background region. It supplies adjustment processing unit information HC indicative of the set adjustment-processing unit, to the modeling section 442 and the supplementation section 444. FIG. 15 shows adjustment processing units in a case where, for example, pixel locations P13-P25 in frame #n of FIG. 9 are each set up as an adjustment-processing unit. It is to be noted that if the movement direction is different from a horizontal or vertical direction, the movement direction can be changed to a horizontal or vertical direction by performing affine transformation in the adjustment-processing unit determination section 441, to perform processing in the same way as in the case where it is horizontal or vertical one.

The modeling section 442 performs modeling based on the motion vector MVC and the set adjustment processing unit information HC. In this modeling, a plurality of models that corresponds to the number of pixels contained in an adjustment-processing unit, a time-directional virtual division number of the image data DVa, and the number of pixel-specific foreground components could be stored beforehand so that a model MD to specify a correlation between the image data DVa and the foreground components may be selected on the basis of the adjustment-processing unit and the time-directional virtual division number of pixel values.

The modeling section 442 supplies the selected model MD to an equation generation section 443. The equation generation section 443 generates an equation based on the model MD supplied from the modeling section 442. Assuming that the adjustment-processing unit is, as described above, pixel locations P13-P25 in frame #n, the movement quantity v is “five pixels”, and the virtual division number is “five”, foreground component FE01 at pixel location C01 and foreground components FE02-FE13 at the respective pixel locations C02-C13 within the adjustment-processing unit can be given by the following equations 16-28:
FE01=F01/v (16)
FE02=F02/v+F01/v (17)
FE03=F03/v+F02/v+F01/v (18)
FE04=F04/v+F03/v+F02/v+F01/v (19)
FE05=F05/v+F04/v+F03/v+F02/v+F01/v (20)
FE06=F06/v+F05/v+F04/v+F03/v+F02/v (21)
FE07=F07/v+F06/v+F05/v+F04/v+F03/v (22)
FE08=F08/v+F07/v+F06/v+F05/v+F04/v (23)
FE09=F09/v+F08/v+F07/v+F06/v+F05/v (24)
FE10=F09/v+F08/v+F07/v+F06/v (25)
FE11=F09/v+F08/v+F07/v (26)
FE12=F09/v+F08/v (27)
FE13=F09/v (28)

The equation generation section 443 changes the generated equations to generate new equations. The following equations 29-41 are generated by the equation generation section 443:
FE01=1·F01/v+0·F02/v+0·F03/v+0·F04/v+0·F05/v+0·F06/v+0·F07/v+0·F08/v+0·F09/v (29)
FE02=1·F01/v+1·F02/v+0·F03/v+0·F04/v+0·F05/v+0·F06/v+0·F07/v+0·F08/v+0·F09/v (30)
FE03=1·F01/v+1·F02/v+1·F03/v+0·F04/v+0·F05/v+0·F06/v+0·F07/v+0·F08/v+0·F09/v (31)
FE04=1·F01/v+1·F02/v+1·F03/v+1·F04/v+0·F05/v+0·F06/v+0·F07/v+0·F08/v+0·F09/v (32)
FE05=1·F01/v+1·F02/v+1·F03/v+1·F04/v+1·F05/v+0·F06/v+0·F07/v+0·F08/v+0·F09/v (33)
FE06=0·F01/v+1·F02/v+1·F03/v+1·F04/v+1·F05/v+1·F06/v+0·F07/v+0·F08/v+0·F09/v (34)
FE07=0·F01/v+0·F02/v+1·F03/v+1·F04/v+1·F05/v+1·F06/v+1·F07/v+0·F08/v+0·F09/v (35)
FE08=0·F01/v+0·F02/v+0·F03/v+1·F04/v+1·F05/v+1·F06/v+1·F07/v+1·F08/v+0·F09/v (36)
FE09=0·F01/v+0·F02/v+0·F03/v+0·F04/v+1·F05/v+1·F06/v+1·F07/v+1·F08/v+1·F09/v (37)
FE10=0·F01/v+1·F02/v+0·F03/v+0·F04/v+0·F05/v+1·F06/v+1·F07/v+1·F08/v+1·F09/v (38)
FE11=0·F01/v+0·F02/v+0·F03/v+0·F04/v+0·F05/v+0·F06/v+1·F07/v+1·F08/v+1·F09/v (39)
FE12=0·F01/v+0·F02/v+0·F03/v+0·F04/v+0·F05/v+0·F06/v+0·F07/v+1·F08/v+1·F09/v (40)
FE13=0·F01/v+0·F02/v+0·F03/v+0·F04/v+0·F05/v+0·F06/v+0·F07/v+0·F08/v+1·F09/v (41)

These equations 29-41 can be expressed also in the following equation 42:

$$FEj = {\sum }_{i = 01}^{09} aij \cdot Fi / v \qquad ( 42 )$$

In Equation 42, j indicates a pixel location in an adjustment-processing unit. In this example, j takes on any one of values 1-13. Further, i indicates a position of a foreground component. In this example, i takes on any one of values 1-9. aij takes on either one of values 0 and 1 in accordance with values of i and j.

Taking into account an error, Equation 42 can be expressed as the following equation 43:

$$FEj = {\sum }_{i = 01}^{09} aij \cdot Fi / v + ej \qquad ( 43 )$$

In Equation 43, ej indicates an error contained in a target pixel Cj. This equation 43 can be rewritten into the following equation 44:

$$ej = FEj - {\sum }_{i = 01}^{09} aij \cdot Fi / v \qquad ( 44 )$$

To apply the least-squares method, a sum E of squares of the errors is defined as given in the following equation 45:

$$E = {\sum }_{j = 01}^{13} {ej}^{2} \qquad ( 45 )$$

To reduce errors to a minimum, a partial differential value due to a variable Fk for the sum E of squares of errors can be made 0, so that Fk is obtained so as to satisfy the following equation 46:

$$\begin{matrix}\frac{\partial E}{\partial Fk} = 2 \cdot {\sum }_{j = 01}^{13} ej \cdot ( \partial ej / \partial Fk ) \\ = 2 \cdot {\sum }_{j = 01}^{13} ( ( FEj - {\sum }_{i = 01}^{09} aij \cdot Fi / v ) \cdot ( - akj / v ) ) = 0\end{matrix} \qquad ( 46 )$$

In Equation 46, a movement quantity v is fixed, so that the following equation 47 can be derived:

$${\sum }_{j = 01}^{13} akj \cdot ( FEj - {\sum }_{i = 01}^{09} aij \cdot Fi / v ) = 0 \qquad ( 47 )$$

Equation 47 can be expanded and transposed to provide the following equation 48:

$${\sum }_{j = 01}^{13} ( akj \cdot {\sum }_{i = 01}^{09} aij \cdot Fi ) = v \cdot {\sum }_{j = 01}^{13} akj \cdot FEj \qquad ( 48 )$$

This equation 48 is expanded into nine equations by substituting any one of integers 1-9 into k in it. These obtained nine equations can in turn be expressed as one equation by using a matrix. This equation is referred to as a normal equation.

An example of such a normal equation generated by the equation generation section 443 based on the least-squares method is given in the following equation 49:

$$[ \begin{matrix}5 & 4 & 3 & 2 & 1 & 0 & 0 & 0 & 0 \\ 4 & 5 & 4 & 3 & 2 & 1 & 0 & 0 & 0 \\ 3 & 4 & 5 & 4 & 3 & 2 & 1 & 0 & 0 \\ 2 & 3 & 4 & 5 & 4 & 3 & 2 & 1 & 0 \\ 1 & 2 & 3 & 4 & 5 & 4 & 3 & 2 & 1 \\ 0 & 1 & 2 & 3 & 4 & 5 & 4 & 3 & 2 \\ 0 & 0 & 1 & 2 & 3 & 4 & 5 & 4 & 3 \\ 0 & 0 & 0 & 1 & 2 & 3 & 4 & 5 & 4 \\ 0 & 0 & 0 & 0 & 1 & 2 & 3 & 4 & 5\end{matrix} ] \cdot [ \begin{matrix}F 01 \\ F 02 \\ F 03 \\ F 04 \\ F 05 \\ F 06 \\ F 07 \\ F 08 \\ F 09\end{matrix} ] = v \cdot [ \begin{matrix}{\sum }_{i = 01}^{05} FE i \\ {\sum }_{i = 02}^{06} FEi \\ {\sum }_{i = 03}^{07} FEi \\ {\sum }_{i = 04}^{08} FEi \\ {\sum }_{i = 05}^{09} FEi \\ {\sum }_{i = 06}^{10} FEi \\ {\sum }_{i = 07}^{11} FEi \\ {\sum }_{i = 08}^{12} FEi \\ {\sum }_{i = 09}^{13} FEi\end{matrix} ] \qquad ( 49 )$$

If this equation 49 is expressed as A·F=v·FE, A and v are known at a point in time of modeling. Further, FE can be known by inputting a pixel value in supplementation, leaving F unknown.

It is thus possible to calculate the foreground component F by using the normal equation that is based on the least-squares method, thereby dispersing errors contained in the pixel value FE. The equation generation section 443 supplies the thus generated normal equation to the supplementation section 444.

The supplementation section 444 sets foreground component image data DBe into a determinant supplied from the equation generation section 443, based on the adjustment processing unit information HC supplied from the adjustment-processing unit determination section 441. Furthermore, the supplementation section 444 supplies a calculation section 445 with the determinant in which image data is set.

The calculation section 445 calculates foreground component Fi/V in which motion blurring is mitigated by performing processing based on a solution such as the sweeping-out method (Gauss-Jordan elimination), to generate pixel values F01-F09 of the foreground in which motion blurring is mitigated. These pixel values F01-F09 thus generated are supplied to the output section 45 at, for example, half a phase of one frame period by setting image positions of the pixel values F01-F09 by using a center of the adjustment-processing unit as a reference so that the foreground component image position may not be changed. That is, as shown in FIG. 16, with pixel values F01-F09 as the respective items of the image data of pixel locations C03-C11, image data DVafc of the foreground component image in which motion blurring is mitigated, is supplied to the output section 45 at a timing of ½ of one frame period.

It is to be noted that if an even number of pixel values is given, for example, when pixel values F01-F08 are obtained, the calculation section 445 outputs either one of central two pixel values F04 and F05 as the center of the adjustment-processing unit. Further, if an exposure lapse of time in one frame is shorter than one frame period because a shutter operation is performed, it is supplied to the output section 45 at half a phase of the exposure lapse of time.

The output section 50 combines the foreground component image data DBf supplied from the motion blurring adjustment section 44 into the background component image data DBb supplied from the foreground/background separation section 43 in the motion-blurring-mitigated object image generation section 40, to generate image data DVout and output it. In this case, the foreground component image in which motion blurring is mitigated is combined into a space-time position that corresponds to the motion vector MVC detected by the motion vector detection section 30. That is, combining the motion-blurring-mitigated foreground component image into a position indicated by the processing region information HZ that is set in accordance with the motion vector MVC allows the motion-blurring-mitigated foreground component image to output with it being properly set to an image position before the motion-blurring-mitigated image is generated.

Thus, it is possible to perform motion-blurring-mitigation processing on moving object with tracking the moving object, thereby generating a motion-blurring-mitigated image of the moving object in an image in which motion blurring is mitigated.

Further, in a processing region in an image, modeling can be performed on the assumption that a pixel value of each pixel in which no motion blurring that corresponds to an moving object occur is integrated in a time direction as it moves in accordance with the motion vector, to extract as significant information a mixture ratio between foreground object component and background object component, thereby separating component of the moving object by utilizing the significant information to accurately mitigate the motion blurring based on this separated component of the moving object.

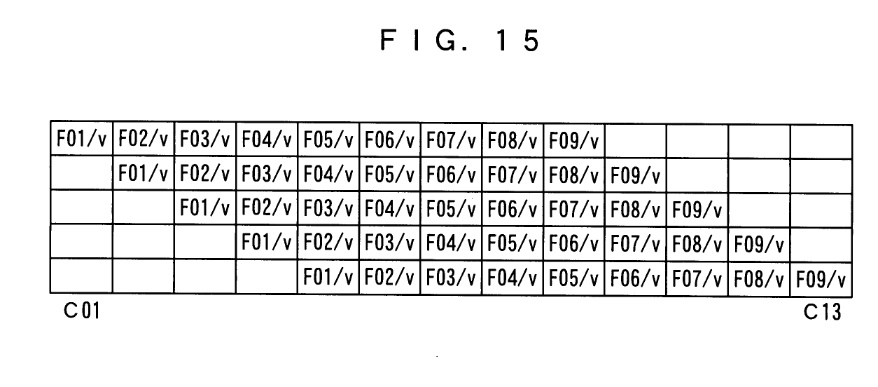

Meanwhile, motion blurring can be mitigated also by using software. FIG. 17 shows a case where the motion blurring is mitigated by using software, as another configuration of the apparatus for processing the image. A central processing unit (CPU) 61 performs a variety of kinds of processing according to a program stored in a read only memory (ROM) 62 or a storage section 63. This storage section 63 is made up of, for example, a hard disk, to store a program to be executed by the CPU61 and a variety of kinds of data. A random access memory (RAM) 64 appropriately stores data etc. to be used when programs to be executed by the CPU61 or various kinds of data are processed. These CPU61, ROM62, storage section 63, and RAM64 are connected to each other through a bus 65.

To the CPU61, an input interface section 66, an output interface section 67, a communication section 68, and a drive 69 are connected via the bus 65. To the input interface 66, an input device such as a keyboard, a pointing device (e.g., mouse), or a microphone is connected. To the output interface section 67, on the other hand, an output device such as a display or a speaker is connected. The CPU61 performs a variety of kinds of processing according to a command input through the input interface section 66. Then, the CPU61 outputs an image, a voice, etc. obtained as a result of the processing, through the output interface section 67. The communication section 68 communicates with an external device via the Internet or any other network. This communication section 68 is used to take in image data DVa output from the image sensor 10, acquire a program, etc. The drive 69, when a magnetic disk, an optical disc, a magneto optical disk, or a semiconductor memory is mounted in it, drives it to acquire a program or data recorded on or in it. The acquired program or data is, as necessary, transferred to the storage section 63 to be stored in it.

The following will describe operations of the apparatus for processing the image with reference to a flowchart of FIG. 18. At step ST1, the CPU 61 acquires image data DVa generated by the image sensor 10 through the input section, the communication section or the like and allows the storage section 63 to store this acquired image data DVa therein.

At step ST2, the CPU 61 sets a processing region under instruction from outside.

At step ST3, the CPU 61 detects a motion vector of moving object OBf that corresponds to a foreground in the processing region determined in the step ST2 by using the image data DVa.

At step ST4, the CPU 61 acquires parameters for exposure lapse of time and the process goes to step ST5 where the motion vector detected at step ST3 is corrected in accordance with the exposure lapse of time, and then the process goes to step ST6.

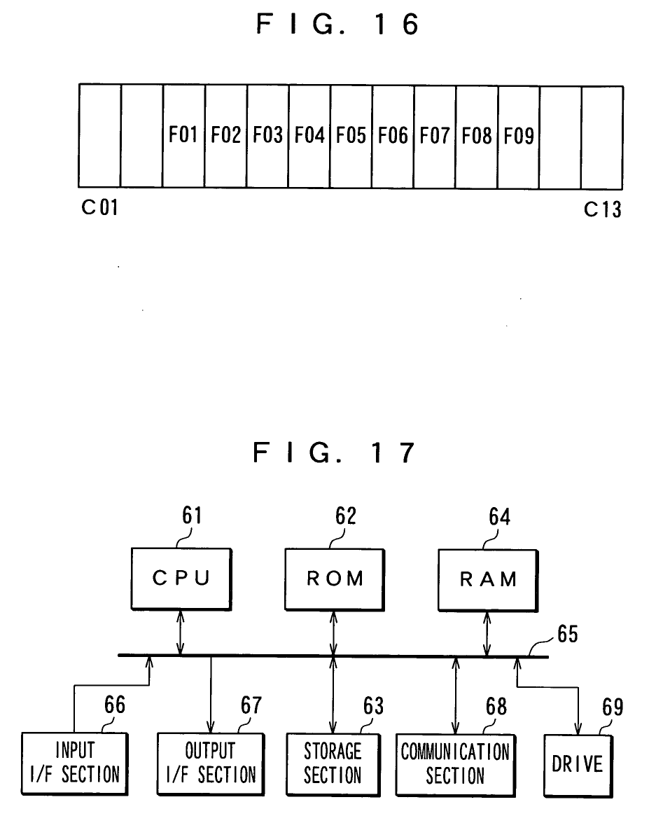

At step ST6, the CPU 61 performs generation processing for a motion-blurring-mitigated object image in order to mitigate motion blurring in the moving object OBf, based on the corrected motion vector, and generates image data in which motion blurring in the moving object OBf is mitigated. FIG. 19 is a flowchart for showing the generation processing for the motion-blurring-mitigated object image.

At step ST11, the CPU61 performs region identification processing on the processing region determined at step ST2, to decide which one of a background region, a foreground region, a covered background region, and an uncovered background region a pixel in the determined processing region belongs to, thereby generating region information. In this generation of the region information, if frame #n is subject to the processing, image data of frames #n−2, #n−1, #n, #n+1, and #n+2 is used to calculate an inter-frame absolute difference value thereof. According to whether this inter-frame absolute difference value is larger than a preset threshold value Th, it decides whether it is included in a moving portion or a still portion and performs region decision based on a result of the decision, thereby generating the region information.

At step ST12, the CPU61 performs mixture ratio calculation processing to calculate on each pixel in the processing region a mixture ratio α indicative of a ratio at which background components are contained by using the region information generated at step ST11, and the process goes to step ST13. In this calculation of the mixture ratio α, for a pixel in the covered background region or the uncovered background region, pixel values of frames #n−1, #n, and #n+1 are used to obtain an estimated mixture ratio αc. Further, the mixture ratio α is set to “1” for the background region and to “0” for the foreground region.

At step ST13, the CPU61 performs foreground/background separation processing to separate image data in the processing region into foreground component image data comprised of only foreground component and background component image data comprised of only background component, based on the region information generated at step ST11 and the mixture ratio α calculated at step ST12. That is, it obtains the foreground component by performing an operation of the above-described equation 12 for a covered background region in frame #n and an operation of the above-described equation 15 for an uncovered background region in it, to separate image data into foreground component image data and background component image data comprised of only background component.

At step ST14, the CPU61 performs motion blurring adjustment processing to determine an adjustment-processing unit indicative of at least one pixel contained in the foreground component image data based on the post-correction motion vector obtained at step ST5 and the region information generated at step ST11, thereby mitigating motion blurring contained in the foreground component image data separated by step ST13. That is, it sets an adjustment-processing unit based on the motion vector MVC, the processing region information HZ, and the region information AR and, based on this motion vector MVC and the set adjustment-processing unit, performs modeling to generate a normal equation. It sets image data to this generated normal equation and performs processing thereon in accordance with the sweeping-out method (Gauss-Jordan elimination), to generate image data of the motion-blurring-mitigated object image, that is, foreground component image data in which motion blurring is mitigated.

At step ST7, the CPU61 performs output processing on a result of the processing to combine the motion-blurring-mitigated foreground component image data generated at step ST14 into a space-time position that corresponds to the motion vector obtained at step ST5 on an image due to the background component image data separated at step ST13, to generate and output image data DVout of the motion-blurring-mitigated image, which is a result of the processing.

At step ST8, the CPU61 decides whether the motion-blurring-mitigation processing should be ended. If, in this case, the motion-blurring-mitigation processing is to be performed on an image of the next frame, the process returns to step ST2 and, otherwise, ends the processing. It is thus possible to perform the motion blurring mitigation processing also by using software.

Although the above embodiment has obtained a motion vector of an object whose motion blurring is to be mitigated and distinguished the processing region containing the object whose motion blurring is to be mitigated into a still region, a moving region, a mixed region, etc. to perform the motion-blurring-mitigation processing by using image data of the moving region and the mixed region, it is possible to mitigate motion blurring without identifying foreground, background, and mixed regions, by performing the motion-blurring-mitigation processing by obtaining a motion vector for each pixel.

In this case, the motion vector detection section 30 obtains a motion vector of a target pixel and supplies it to the motion-blurring-mitigated object image generation section 40. Further, it supplies the output section with processing region information HD that indicates a pixel location of the target pixel.

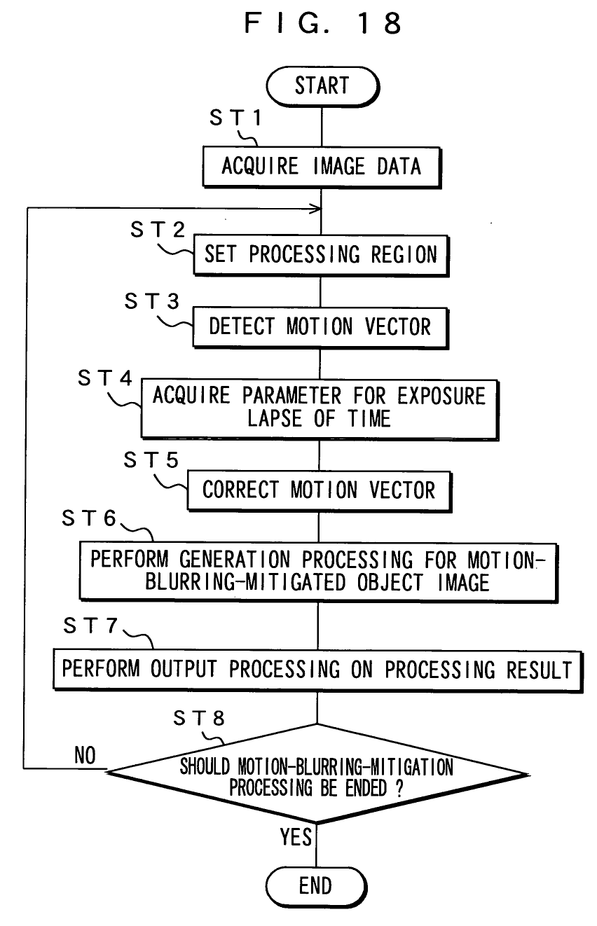

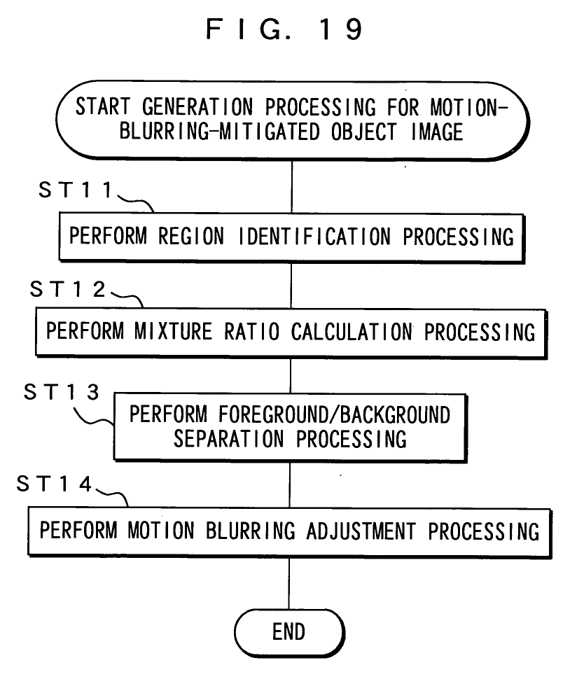

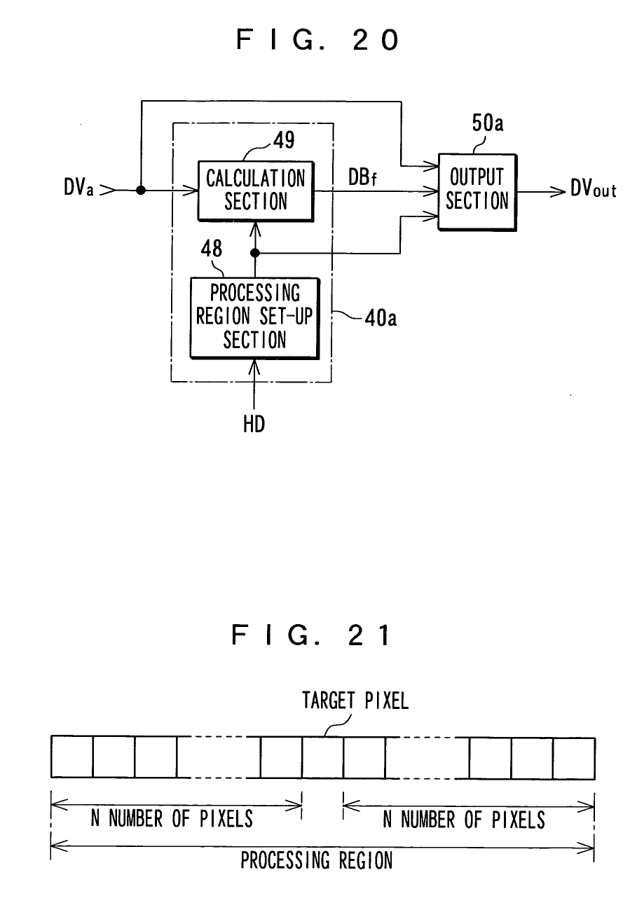

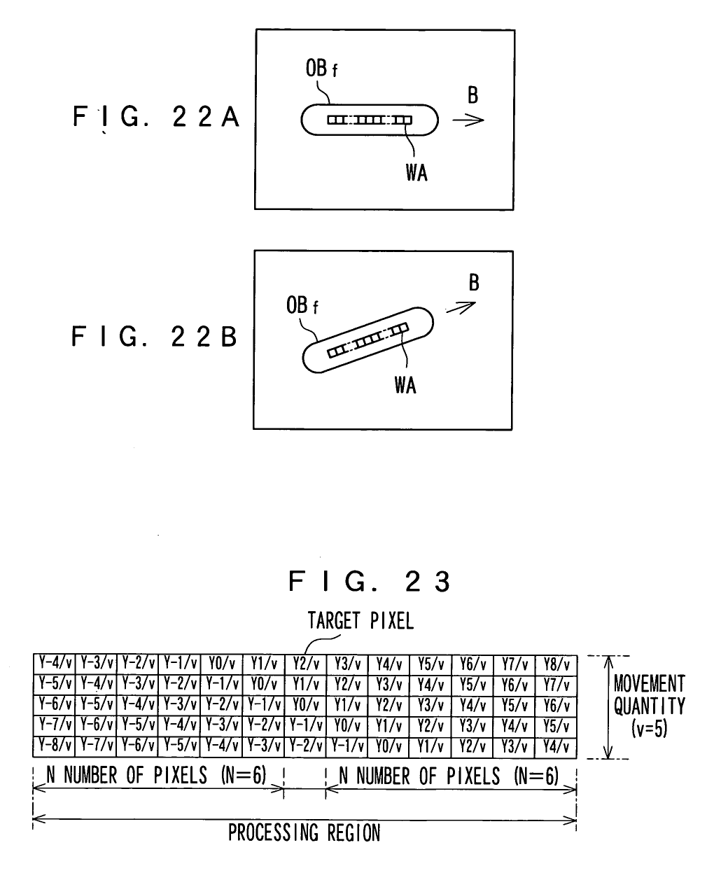

FIG. 20 shows a configuration of a motion-blurring-mitigated object image generation section 40a that can mitigate motion blurring without identifying foreground, background, and mixed regions. A processing region set-up section 48 in the moving-blurring-mitigated object image generation section 40a sets up a processing region for a target pixel on an image whose motion blurring is to be mitigated in such a manner that this processing region may be aligned with a movement direction of a motion vector for this target pixel and then notifies a calculation section 49 of it. Further, it supplies a position of the target pixel to an output section 45a. FIG. 21 shows a processing region which is set up so as to have (2N+1) number of pixels in the movement direction around the target pixel as a center. FIG. 22 show examples of setting up a processing region; if a motion vector runs, for example, horizontal as shown by an arrow B with respect to pixels of a moving object OBf whose motion blurring is to be mitigated, a processing region WA is set up horizontally as shown in FIG. 22A. If the motion vector runs obliquely, on the other hand, the processing region WA is set up in a relevant angle direction as shown in FIG. 22B. However, to set up a processing region obliquely, a pixel value that corresponds to a pixel location of the processing region must be obtained by interpolation etc.

In this case, in the processing region, as shown in FIG. 23, actual world variables (Y₋₈, . . . , Y₀, . . . , Y₈) are mixed time-wise. It is to be noted that FIG. 23 shows a case where a movement quantity v is set to 5 (v=5) and the processing region comprises 13 pixels (N=6, where N is the number of pixels of a processing width for the target pixel).

The calculation section 49 performs actual world estimation on this processing region, to output only center pixel variable Y₀ of an estimated actual world as a pixel value of the target pixel whose motion blurring has been removed.

Assuming here that pixel values of pixels in the processing region are X_{-N}, X_{-N+1}, . . . , X₀, . . . , X_{N-1}, X_{N}, (2N+1) number of mixed equations such as shown in Equation 50 are established. In this equation, a constant h indicates a value (whose decimal places are truncated) of an integer part obtained by multiplying the movement quantity by (½).

$${\sum }_{i = t - h}^{t + h} ( Yi / v ) = Xt \\ ( t = - N , ⋯ , 0 , ⋯ , N ) \qquad ( 50 )$$

However, there are (2N+v) number of actual world variables (Y_{-N-h}, Y₀, Y_{N+h}) to be obtained. That is, numbers of the equations is less than those of the variables, so that it is impossible to obtain the actual world variables (Y_{-N-h}, Y₀, and Y_{N+h}) according to Equation 50.

Consequently, by increasing the numbers of the equations over the numbers of the actual world variables by using the following equation 51, which is a restriction equation that employs space correlations, values of the actual world variables are obtained using the least-squares method.
Yₜ−Yₜ₊₁=0 (51)
(t=−N−h, . . . , 0, . . . , N+h−1)

That is, the (2N+v) number of actual world variables (Y_{-N-h}, . . . , Y₀, . . . , Y_{N+h}), which are unknown, are obtained by using a total (4N+v) number of equations obtained by adding up (2n+1) number of mixed equations represented by Equation 50 and (2N+v−1) number of restriction equations represented by Equation 51.

It is to be noted that by performing estimation in such a manner as to minimize a sum of squares of errors that occur in these equations, it is possible to suppress fluctuations in pixel values in the actual world as performing motion-blurring-mitigated image generation processing.

The following equation 52 indicates a case where the processing region is set up as shown in FIG. 23, in which errors that occur in the equations are added to the respective equations 50 and 51.

$$[ \begin{matrix}1 / v & 1 / v & 1 / v & 1 / v & 1 / v & 0 & 0 & 0 & 0 & 0 & 0 & 0 & 0 & 0 & 0 & 0 & 0 \\ 0 & 1 / v & 1 / v & 1 / v & 1 / v & 1 / v & 0 & 0 & 0 & 0 & 0 & 0 & 0 & 0 & 0 & 0 & 0 \\ 0 & 0 & 1 / v & 1 / v & 1 / v & 1 / v & 1 / v & 0 & 0 & 0 & 0 & 0 & 0 & 0 & 0 & 0 & 0 \\ 0 & 0 & 0 & 1 / v & 1 / v & 1 / v & 1 / v & 1 / v & 0 & 0 & 0 & 0 & 0 & 0 & 0 & 0 & 0 \\ 0 & 0 & 0 & 0 & 1 / v & 1 / v & 1 / v & 1 / v & 1 / v & 0 & 0 & 0 & 0 & 0 & 0 & 0 & 0 \\ 0 & 0 & 0 & 0 & 0 & 1 / v & 1 / v & 1 / v & 1 / v & 1 / v & 0 & 0 & 0 & 0 & 0 & 0 & 0 \\ 0 & 0 & 0 & 0 & 0 & 0 & 1 / v & 1 / v & 1 / v & 1 / v & 1 / v & 0 & 0 & 0 & 0 & 0 & 0 \\ 0 & 0 & 0 & 0 & 0 & 0 & 0 & 1 / v & 1 / v & 1 / v & 1 / v & 1 / v & 0 & 0 & 0 & 0 & 0 \\ 0 & 0 & 0 & 0 & 0 & 0 & 0 & 0 & 1 / v & 1 / v & 1 / v & 1 / v & 1 / v & 0 & 0 & 0 & 0 \\ 0 & 0 & 0 & 0 & 0 & 0 & 0 & 0 & 0 & 1 / v & 1 / v & 1 / v & 1 / v & 1 / v & 0 & 0 & 0 \\ 0 & 0 & 0 & 0 & 0 & 0 & 0 & 0 & 0 & 0 & 1 / v & 1 / v & 1 / v & 1 / v & 1 / v & 0 & 0 \\ 0 & 0 & 0 & 0 & 0 & 0 & 0 & 0 & 0 & 0 & 0 & 1 / v & 1 / v & 1 / v & 1 / v & 1 / v & 0 \\ 0 & 0 & 0 & 0 & 0 & 0 & 0 & 0 & 0 & 0 & 0 & 0 & 1 / v & 1 / v & 1 / v & 1 / v & 1 / v \\ 1 & - 1 & 0 & 0 & 0 & 0 & 0 & 0 & 0 & 0 & 0 & 0 & 0 & 0 & 0 & 0 & 0 \\ 0 & 1 & - 1 & 0 & 0 & 0 & 0 & 0 & 0 & 0 & 0 & 0 & 0 & 0 & 0 & 0 & 0 \\ 0 & 0 & 1 & - 1 & 0 & 0 & 0 & 0 & 0 & 0 & 0 & 0 & 0 & 0 & 0 & 0 & 0 \\ 0 & 0 & 0 & 1 & - 1 & 0 & 0 & 0 & 0 & 0 & 0 & 0 & 0 & 0 & 0 & 0 & 0 \\ 0 & 0 & 0 & 0 & 1 & - 1 & 0 & 0 & 0 & 0 & 0 & 0 & 0 & 0 & 0 & 0 & 0 \\ 0 & 0 & 0 & 0 & 0 & 1 & - 1 & 0 & 0 & 0 & 0 & 0 & 0 & 0 & 0 & 0 & 0 \\ 0 & 0 & 0 & 0 & 0 & 0 & 1 & - 1 & 0 & 0 & 0 & 0 & 0 & 0 & 0 & 0 & 0 \\ 0 & 0 & 0 & 0 & 0 & 0 & 0 & 1 & - 1 & 0 & 0 & 0 & 0 & 0 & 0 & 0 & 0 \\ 0 & 0 & 0 & 0 & 0 & 0 & 0 & 0 & 1 & - 1 & 0 & 0 & 0 & 0 & 0 & 0 & 0 \\ 0 & 0 & 0 & 0 & 0 & 0 & 0 & 0 & 0 & 1 & - 1 & 0 & 0 & 0 & 0 & 0 & 0 \\ 0 & 0 & 0 & 0 & 0 & 0 & 0 & 0 & 0 & 0 & 1 & - 1 & 0 & 0 & 0 & 0 & 0 \\ 0 & 0 & 0 & 0 & 0 & 0 & 0 & 0 & 0 & 0 & 0 & 1 & - 1 & 0 & 0 & 0 & 0 \\ 0 & 0 & 0 & 0 & 0 & 0 & 0 & 0 & 0 & 0 & 0 & 0 & 1 & - 1 & 0 & 0 & 0 \\ 0 & 0 & 0 & 0 & 0 & 0 & 0 & 0 & 0 & 0 & 0 & 0 & 0 & 1 & - 1 & 0 & 0 \\ 0 & 0 & 0 & 0 & 0 & 0 & 0 & 0 & 0 & 0 & 0 & 0 & 0 & 0 & 1 & - 1 & 0 \\ 0 & 0 & 0 & 0 & 0 & 0 & 0 & 0 & 0 & 0 & 0 & 0 & 0 & 0 & 0 & 1 & - 1\end{matrix} ] [ \begin{matrix}{Y}_{- 8} \\ {Y}_{- 7} \\ {Y}_{- 6} \\ {Y}_{- 5} \\ {Y}_{- 4} \\ {Y}_{- 3} \\ {Y}_{- 2} \\ {Y}_{- 1} \\ {Y}_{0} \\ {Y}_{1} \\ {Y}_{2} \\ {Y}_{3} \\ {Y}_{4} \\ {Y}_{5} \\ {Y}_{6} \\ {Y}_{7} \\ {Y}_{8}\end{matrix} ] = [ \begin{matrix}{X}_{- 6} \\ {X}_{- 5} \\ {X}_{- 4} \\ {X}_{- 3} \\ {X}_{- 2} \\ {X}_{- 1} \\ {X}_{0} \\ {X}_{1} \\ {X}_{2} \\ {X}_{3} \\ {X}_{4} \\ {X}_{5} \\ {X}_{6} \\ 0 \\ 0 \\ 0 \\ 0 \\ 0 \\ 0 \\ 0 \\ 0 \\ 0 \\ 0 \\ 0 \\ 0 \\ 0 \\ 0 \\ 0 \\ 0\end{matrix} ] + [ \begin{matrix}{e}_{{m}_{- 6}} \\ {e}_{{m}_{- 5}} \\ {e}_{{m}_{- 4}} \\ {e}_{{m}_{- 3}} \\ {e}_{{m}_{- 2}} \\ {e}_{{m}_{- 1}} \\ {e}_{{m}_{0}} \\ {e}_{{m}_{1}} \\ {e}_{{m}_{2}} \\ {e}_{{m}_{3}} \\ {e}_{{m}_{4}} \\ {e}_{{m}_{5}} \\ {e}_{{m}_{6}} \\ {e}_{{b}_{0}} \\ {e}_{{b}_{1}} \\ {e}_{{b}_{2}} \\ {e}_{{b}_{3}} \\ {e}_{{b}_{4}} \\ {e}_{{b}_{5}} \\ {e}_{{b}_{6}} \\ {e}_{{b}_{7}} \\ {e}_{{b}_{8}} \\ {e}_{{b}_{9}} \\ {e}_{{b}_{10}} \\ {e}_{{b}_{11}} \\ {e}_{{b}_{12}} \\ {e}_{{b}_{13}} \\ {e}_{{b}_{14}} \\ {e}_{{b}_{15}}\end{matrix} ] \qquad ( 52 )$$

This equation 52 can be changed into Equation 53, so that Y(=Yi) that minimizes a sum of squares E of errors given in Equation 54 is obtained as Equation 55. In Equation 55, T indicates a transposed matrix.
AY=X+e (53)
E=|e|²=Σemi²+Σebi² (54)
Y=(A^{T}A)⁻¹A^{T}X (55)

It is to be noted that the sum of squares of errors is such as given by Equation 56, so that by partially differentiating this sum of squares of errors, a partial differential value may be 0 as given in Equation 57, thereby enabling Equation 55 that minimizes the sum of squares of errors to be obtained.

$$\begin{matrix}\begin{matrix}E = {( A \cdot Y - X )}^{T} ( A \cdot Y - X ) \\ = {Y}^{T} \cdot {A}^{T} \cdot A \cdot Y - 2 \cdot {Y}^{T} \cdot {A}^{T} \cdot X + {X}^{T} \cdot X\end{matrix} & ( 56 ) \\ \frac{\partial E}{\partial Y} = 2 ( {A}^{T} \cdot A \cdot Y - {A}^{T} \cdot X ) = 0 & ( 57 )\end{matrix}$$

Performing linear combination on this equation 55 allows the actual world variables (Y_{-N-h}, Y₀, and Y_{N+h}) to be respectively obtained, to output a pixel value of the central pixel variable Y₀ as a pixel value of the target pixel. For example, the calculation section 49 stores a matrix (A^{T}A)⁻¹A^{T} obtained beforehand for each movement quantity and outputs the pixel value of the central pixel variable Y₀ as a target value based on a matrix that corresponds to the movement quantity and a pixel value of a pixel in the processing region. Performing such the processing on all of the pixels in the processing region allows actual world variables in each of which motion blurring is mitigated to be obtained for all over the screen or over a region specified by a user.

Although the above embodiment has obtained actual world variables (Y_{-N-h}, . . . , Y₀, . . . , Y_{N+h}) by using the least-squares method in such a manner as to minimize the sum of squares E of errors in AY=X+e, the following equation 58 can be given so that the number of the equations may be equal to the number of the variables. By expressing this equation as AY=X and modifying it into Y=A⁻¹X, it is possible also to obtain the actual world variables (Y_{-N-h}, . . . , Y₀, . . . , Y_{N+h}).

$$[ \begin{matrix}1 / v & 1 / v & 1 / v & 1 / v & 1 / v & 0 & 0 & 0 & 0 & 0 & 0 & 0 & 0 & 0 & 0 & 0 & 0 \\ 0 & 1 / v & 1 / v & 1 / v & 1 / v & 1 / v & 0 & 0 & 0 & 0 & 0 & 0 & 0 & 0 & 0 & 0 & 0 \\ 0 & 0 & 1 / v & 1 / v & 1 / v & 1 / v & 1 / v & 0 & 0 & 0 & 0 & 0 & 0 & 0 & 0 & 0 & 0 \\ 0 & 0 & 0 & 1 / v & 1 / v & 1 / v & 1 / v & 1 / v & 0 & 0 & 0 & 0 & 0 & 0 & 0 & 0 & 0 \\ 0 & 0 & 0 & 0 & 1 / v & 1 / v & 1 / v & 1 / v & 1 / v & 0 & 0 & 0 & 0 & 0 & 0 & 0 & 0 \\ 0 & 0 & 0 & 0 & 0 & 1 / v & 1 / v & 1 / v & 1 / v & 1 / v & 0 & 0 & 0 & 0 & 0 & 0 & 0 \\ 0 & 0 & 0 & 0 & 0 & 0 & 1 / v & 1 / v & 1 / v & 1 / v & 1 / v & 0 & 0 & 0 & 0 & 0 & 0 \\ 0 & 0 & 0 & 0 & 0 & 0 & 0 & 1 / v & 1 / v & 1 / v & 1 / v & 1 / v & 0 & 0 & 0 & 0 & 0 \\ 0 & 0 & 0 & 0 & 0 & 0 & 0 & 0 & 1 / v & 1 / v & 1 / v & 1 / v & 1 / v & 0 & 0 & 0 & 0 \\ 0 & 0 & 0 & 0 & 0 & 0 & 0 & 0 & 0 & 1 / v & 1 / v & 1 / v & 1 / v & 1 / v & 0 & 0 & 0 \\ 0 & 0 & 0 & 0 & 0 & 0 & 0 & 0 & 0 & 0 & 1 / v & 1 / v & 1 / v & 1 / v & 1 / v & 0 & 0 \\ 0 & 0 & 0 & 0 & 0 & 0 & 0 & 0 & 0 & 0 & 0 & 1 / v & 1 / v & 1 / v & 1 / v & 1 / v & 0 \\ 0 & 0 & 0 & 0 & 0 & 0 & 0 & 0 & 0 & 0 & 0 & 0 & 1 / v & 1 / v & 1 / v & 1 / v & 1 / v \\ 1 & - 1 & 0 & 0 & 0 & 0 & 0 & 0 & 0 & 0 & 0 & 0 & 0 & 0 & 0 & 0 & 0 \\ 0 & 1 & - 1 & 0 & 0 & 0 & 0 & 0 & 0 & 0 & 0 & 0 & 0 & 0 & 0 & 0 & 0 \\ 0 & 0 & 1 & - 1 & 0 & 0 & 0 & 0 & 0 & 0 & 0 & 0 & 0 & 0 & 0 & 0 & 0 \\ 0 & 0 & 0 & 1 & - 1 & 0 & 0 & 0 & 0 & 0 & 0 & 0 & 0 & 0 & 0 & 0 & 0\end{matrix} ] [ \begin{matrix}{Y}_{- 8} \\ {Y}_{- 7} \\ {Y}_{- 6} \\ {Y}_{- 5} \\ {Y}_{- 4} \\ {Y}_{- 3} \\ {Y}_{- 2} \\ {Y}_{- 1} \\ {Y}_{0} \\ {Y}_{1} \\ {Y}_{2} \\ {Y}_{3} \\ {Y}_{4} \\ {Y}_{5} \\ {Y}_{6} \\ {Y}_{7} \\ {Y}_{8}\end{matrix} ] = [ \begin{matrix}{X}_{- 6} \\ {X}_{- 5} \\ {X}_{- 4} \\ {X}_{- 3} \\ {X}_{- 2} \\ {X}_{- 1} \\ {X}_{0} \\ {X}_{1} \\ {X}_{2} \\ {X}_{3} \\ {X}_{4} \\ {X}_{5} \\ {X}_{6} \\ 0 \\ 0 \\ 0 \\ 0\end{matrix} ] \qquad ( 58 )$$

The output section 50a brings a pixel value of the central pixel variable Y0 that is obtained by the motion-blurring-mitigated object image generation section 40 into a pixel value of a target pixel. Further, if the central pixel variable Y₀ cannot be obtained because a background region or a mixed region is indicated, a pixel value of the target pixel before the generation processing for motion-blurring-mitigated image is performed is used to generate the image data DVout.

In such a manner, even if movement of a moving object for each pixel differs from each other, it is possible to estimate an actual world by using a motion vector that corresponds to a target pixel, thereby performing accurate generation processing of the motion-blurring-mitigated image. For example, even if a moving object cannot be supposed to be rigid, it is possible to mitigate motion blurring of an image of the moving object.

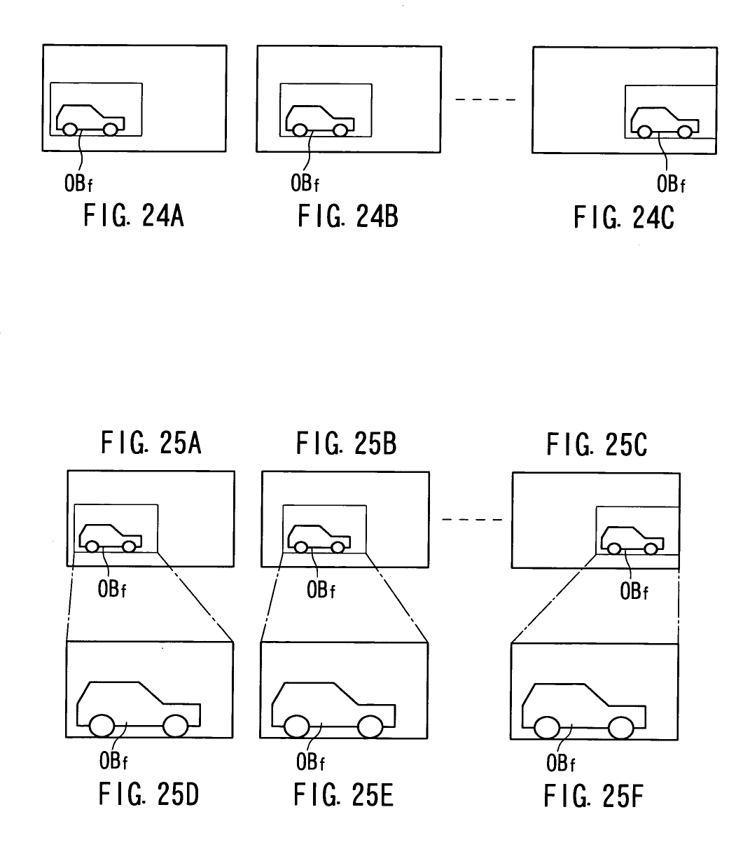

Meanwhile, in the above embodiments, motion blurring of an moving object OBf is mitigated to output its image, so that, as shown in FIG. 24 even when the moving object OBf moves in an order of FIGS. 24A, 24B, and 24C, motion blurring of this moving object OBf has been mitigated as tracking it, thereby outputting a good image thereof in which motion blurring of this moving object OBf has been mitigated. However, alternatively, by controlling a display position of an image so that the image of the motion-blurring-mitigated moving object OBf may be located to a predetermined position on a screen on the basis of the moving object OBf, such an image can be output as to track the moving object OBf.

In this case, the motion vector detection section 30 moves a tracking point set in a region indicated by the region selection information HA in accordance with a motion vector MV, to supply the output section 50 with coordinates information HG that indicates the tracking point after this movement. The output section 50 generates such the image data DVout that the tracking point indicated by the coordinates information HG may be located to the predetermined position on the screen. It is thus possible to output an image as if the moving object OBf is being tracked.

Furthermore, by generating an expanded image using the motion-blurring-mitigated image data DVout, it is possible to output this expanded image to a position, in a time direction, corresponding to a motion vector. This is, by using a moving object OBf as a reference, by using as a reference a tracking point set in a region indicated by the region selection information HA and outputting the expanded image in such a manner that the tracking point may be located to a predetermined position on the screen, it is possible to output the expanded image of the moving object OBf as tracking this moving object OBf as shown in FIGS. 25D-25F even if it moves as shown in FIGS. 25A-25C. In this case, since the expanded image of the moving object OBf is displayed up to a size of an image frame of the image, even if the display image is moved so that the tracking point may be located to the predetermined position on the screen, it is possible to prevent no-display portion from occurring on the screen. Further, an expanded image can be generated by repeating a pixel value of a pixel in which motion blurring is mitigated. For example, by repeating each pixel value twice, it is possible to generate an expanded image that has double vertical and horizontal sizes. Further, by using an average etc. of adjacent pixels as a new pixel value, a new pixel can be placed between these adjacent pixels to generate an expanded image. Furthermore, by using a motion-blurring-mitigated image to create a space resolution, it is possible to output a high-definition expanded image with less motion blurring. The following will describe a case where space resolution creation is performed to generate an expanded image.

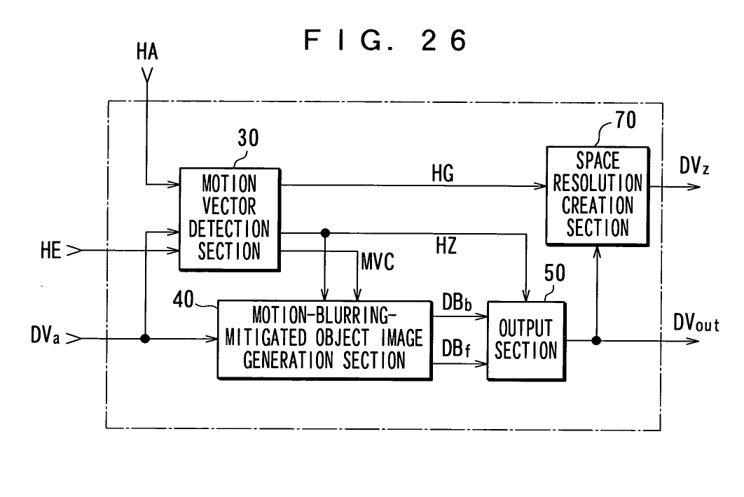

FIG. 26 shows such another configuration of an apparatus for processing an image by which space resolution creation may be performed to enable an expanded image to be generated. In FIG. 26, like components that correspond to those of FIG. 5 are indicated by like symbols, detailed description of which will be omitted.

Coordinates information HG generated by the motion vector detection section 30 is supplied to a space resolution creation section 70. Further, image data DVout of a motion-blurring-mitigated image output from the output section 50 is supplied to the space resolution creation section 70.

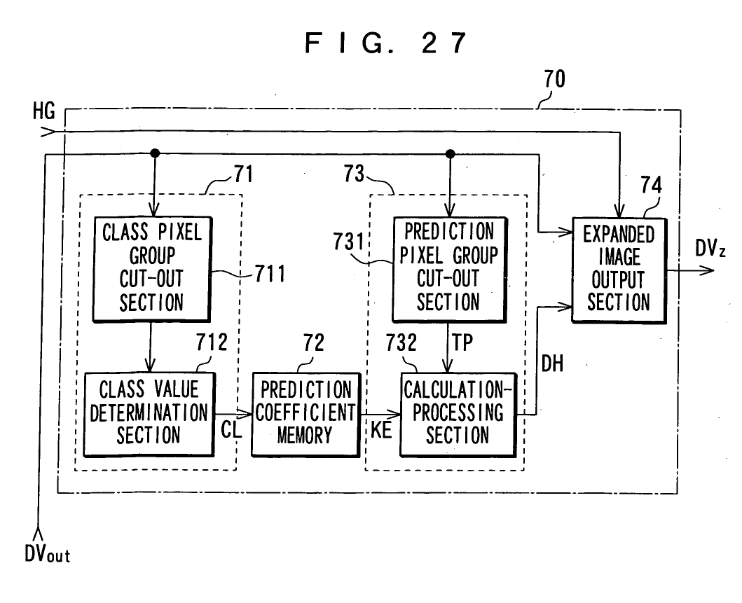

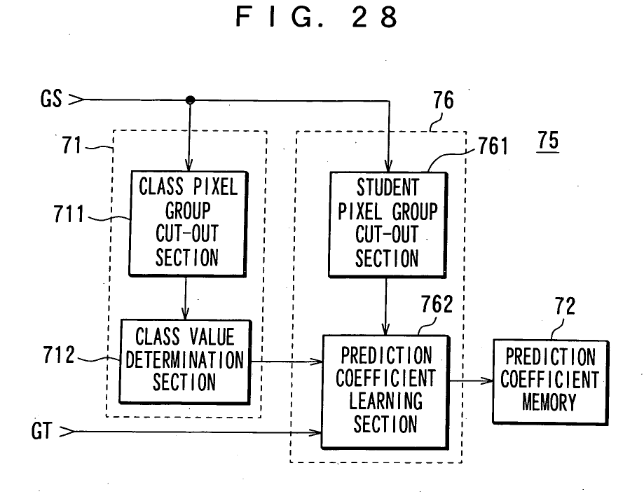

FIG. 27 shows a configuration of the space resolution creation section. The motion-blurring-mitigated image data DVout is supplied to the space resolution creation section 70.

The space resolution creation section 70 comprises a class classification section 71 for classifying target pixels of the image data DVout into classes, a prediction coefficient memory 72 for outputting a prediction coefficient that corresponds to a result of classification by the class classification section 71, a prediction calculation section 73 for generating interpolation pixel data DH by performing prediction operations by using the prediction coefficient output from the prediction coefficient memory 72 and the image data DVout, and an expanded image output section 74 for reading an image after the space resolution creation by as much as display pixels based on the coordinates information HG supplied from the motion vector detection section 30 and outputting image data DVz of an expanded image.

The image data DVout is supplied to a class pixel group cut-out section 711 in the class classification section 71, a prediction pixel group cut-out section 731 in the prediction calculation section 73, and the expanded image output section 74. The class pixel group cut-out section 711 cuts out pixels necessary for class classification (movement class) for the purpose of representing a degree of movement. A pixel group cut out by this class pixel group cut-out section 711 is supplied to a class value determination section 712. The class value determination section 712 calculates an inter-frame difference about pixel data of the pixel group cur out by the class pixel group cut-out section 711 and classifies, for example, absolute average values of these inter-frame differences into classes by comparing these average values to a plurality of preset threshold values, thereby determining a class value CL.

The prediction coefficient memory 72 stores prediction coefficients in it and supplies the prediction calculation section 73 with a prediction coefficient KE that corresponds to a class value CL determined by the class classification section 71.

The prediction pixel group cut-out section 731 in the prediction calculation section 73 cuts out pixel data (i.e., prediction tap) TP to be used in prediction calculation from the image data DVout 1D and supplies it to a calculation-processing section 732. The calculation-processing section 732 performs first-degree linear operations by using each of the prediction coefficient KE supplied from the prediction coefficient memory 72 and the prediction tap TP, thereby calculating interpolation pixel data DH that corresponds to a target pixel and supply it to the expanded image output section 74.

The expanded image output section 74 generates and outputs image data DVz of an expanded image by reading the image data by as much as a display size from the image data DVout and the interpolation pixel data DH so that a position based on the coordinates information HG may be located to a predetermined position on a screen.

By thus generating the expanded image and using generated interpolation pixel data DH and image data DVout, it is possible to output the expanded high-quality image in which motion blurring is mitigated. For example, by generating interpolation pixel data DH and doubling the numbers of horizontal and vertical pixels, it is possible to output a high-quality image such that a moving object OBf is doubled vertically and horizontally with its moving blurring being mitigated.

It is to be noted that prediction coefficients stored in the prediction coefficient memory 72 can be created by using a learning device shown in FIG. 28. In FIG. 28, like components corresponding to those of FIG. 27 are indicated by like symbols.

The learning device 75 has a class classification section 71, a prediction coefficient memory 72, and a coefficient calculation section 76. To the class classification section 71 and the coefficient calculation section 76, image data GS of a student image generated by reducing the number of pixels of a teacher signal is supplied.

The class classification section 71 cuts out, from the image data GS of the student image, pixels necessary for class classification by using the class pixel group cut-out section 711 and classifies this cut-out group of pixels into classes by using pixel data of this group, thereby determining a class value.

A student pixel group cut-out section 761 in the coefficient calculation section 76 cuts out, from the student image's image data GS, pixel data to be used in calculation of a prediction coefficient and supplies it to a prediction coefficient learning section 762.

The prediction coefficient learning section 762 generates a normal equation by using image data GT of the teacher image, the image data from the student pixel group cut-out section 761, and the prediction coefficient for each class indicated by the class value supplied from the class classification section 71. Furthermore, it solves the normal equation in terms of a prediction coefficient by using a generic matrix solution such as the sweeping-out method and stores an obtained coefficient in the prediction coefficient memory 72.

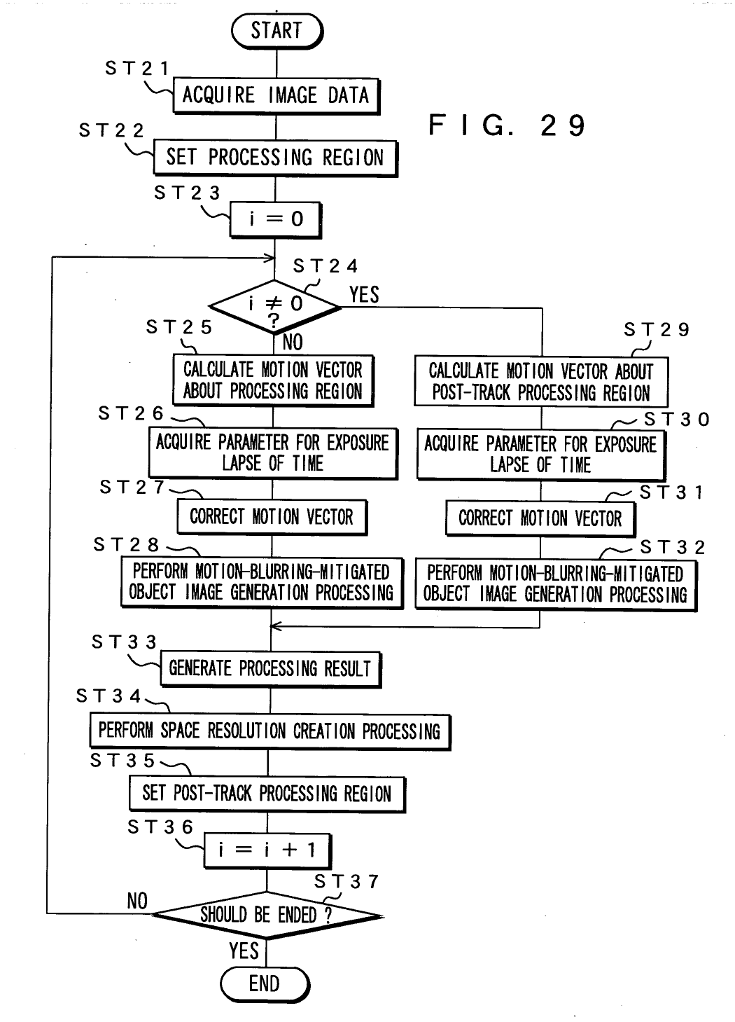

FIG. 29 is a flowchart for showing operations in a case where space resolution creation processing is combined.

At step ST21, the CPU61 acquires image data DVa and the process goes to step ST22.

At step ST22, the CPU61 sets a processing region and the process goes to step ST23.

At step ST23, the CPU61 sets variable i to 0 (i=0) and the process goes to step ST24.

At step ST24, the CPU61 decides whether variable i does not equal 0 (i≠0). If not i≠0, the process goes to step ST25 and, if i≠0, the process goes to step ST29.

At step ST25, the CPU61 detects a motion vector about the processing region set up at step ST22 and the process goes to step ST26.

At step ST26, the CPU61 acquires a parameter for exposure lapse of time and the process goes to step ST27 where the motion vector detected at step ST25 is corrected in accordance with the parameter for the exposure lapse of time, and then the process goes to step ST28.

At step ST28, the CPU61 performs motion-blurring-mitigated object image generation processing shown in FIG. 19 by using the post-correction motion vector and the image data DVa to generate a motion-blurring-mitigated image of the moving object and the process goes to step ST33.

At step ST33, the CPU61 generates a processing result and combines foreground component image data in which motion blurring is mitigated into background component image data at a space-time position that corresponds to the motion vector obtained at step ST27, thereby generating image data DVout as a result of the processing.

At step ST34, the CPU61 performs space resolution creation processing by using the image data DVout generated at step ST33 and generates image data DVz of the expanded image having a display screen size such that a position indicated by the coordinate information HG can be located at a fixed position on a screen.

At step ST35, the CPU61 moves the processing region in accordance with movements of the moving object to set up a post-track processing region and the process goes to step ST36. In this set-up of the post-track processing region, for example, a motion vector MV of the moving object OBf is detected and used. Alternatively, a motion vector detected at step ST25 or ST29 is used.

At step ST36, the CPU61 sets variable i to i+1 (i=i+1) and the process goes to step ST37.

A step ST37, the CPU61 decides whether the processing should be ended. If it is decided at this step that the processing should be not ended, the process returns to step ST24.

If the process returns from step ST37 to step ST24 where the CPU61 performs its processing, the process goes to step ST29 because variable i does not equal 0 (i≠0), to detect a motion vector about the post-track processing region at step ST29 and the process goes to step ST30.

At steps ST30-ST32, the CPU61 performs the same processing as that performed at steps ST26-ST28 and the process goes to step ST33. The CPU61 repeats processing starting from step ST33. Then, if the image data Dva is completed or a stop operation is carried out, it is decided that the operation is ended, thereby finishing the processing.

It is to be noted that according to the processing shown in FIG. 2529, when an image is displayed based on the result of the processing generated at step ST33, it is possible to obtain such the displayed image shown in FIG. 24.

Thus, it is possible to output an expanded image of the moving object OBf with the moving object OBf being tracked.

### INDUSTRIAL APPLICABILITY

As described above, an apparatus for processing an image, a method for processing an image, and a program therefor related to the present invention are useful in mitigation of motion blurring in an image, thus being well suited for mitigation of motion blurring in an image shot by a video camera.

1. An apparatus for processing an image, said apparatus comprising:
motion vector detection means for detecting a motion vector about a moving object that moves in multiple images, each of which is made up of multiple pixels and acquired by an image sensor having time integration effects, and tracking the moving object;
motion-blurring-mitigated object image generation means for generating a motion-blurring-mitigated object image in which motion 1D blurring occurred in the moving object in each image of the multiple images is mitigated by using the motion vector detected by the motion vector detection means; and
output means for combining the motion-blurring-mitigated object image that is generated in the motion-blurring-mitigated object image generation means into a space-time location, in each image, corresponding to the motion vector, said motion vector being detected by the motion vector detection means, to output it as a motion-blurring-mitigated image.

2. The apparatus for processing the image according to claim 1, wherein the motion vector detection means sets a target pixel corresponding to a location of the moving object in any one of at least a first image and a second image, which are sequential in terms of time, and detects a motion vector corresponding to the target pixel by using the first and second images; and
wherein the output means combines the motion-blurring-mitigated object image into a location of the target pixel in said one of the images or a location corresponding to the target pixel in the other image, said locations corresponding to the detected motion vector.

3. The apparatus for processing the image according to claim 1, wherein in a processing region of the image, the motion-blurring-mitigated object image generation means turns into a model so that a pixel value of each pixel in which no motion blurring corresponding to the moving object occur becomes a value obtained by integrating the pixel value in a time direction with the pixel being moved corresponding to the motion vector and generates a motion-blurring-mitigated object image in which motion blurring of the moving object included in the processing region is mitigated, based on the pixel value of the pixel in the processing region.

4. The apparatus for processing the image according to claim 3, wherein the motion-blurring-mitigated object image generation means includes:
region identification means for identifying a foreground region, a background region, and a mixed region in the processing region, said foreground region being composed of only a foreground object component constituting a foreground object which is moving object, said background region being composed of only a background object component constituting a background object, and said mixed region mixing the foreground object component and the background object component;
mixture ratio detection means for detecting a mixture ratio of the foreground object component and the background object component in the mixed region;
separation means for separating at least a part of region of the image into the foreground object and the background object, based on the mixture ratio; and
motion-blurring-adjusting means for mitigating motion blurring of the foreground object separated by the separation means based on the motion vector.

5. The apparatus for processing the image according to claim 3, wherein the motion vector detection means detects the motion vector every pixel in the image; and
wherein the motion-blurring-mitigated object image generation means sets the processing region according to the motion vector of the target pixel in the image so that the processing region includes the target pixel, and outputs pixel value in which motion blurring of the target pixel is mitigated in pixel units based on the motion vector of the target pixel.

6. The apparatus for processing the image according to claim 1, further comprising expanded image generation means for generating an expanded image based on the motion-blurring-mitigated image,
wherein the output means outputs the expanded image to a location corresponding to the motion vector in a time direction.

7. The apparatus for processing the image according to claim 6, wherein the expanded image generation means includes:
class determination means for extracting multiple pixels corresponding to a target pixel in the expanded image as a class tap from the motion-blurring-mitigated image and determining a class corresponding to the target pixel based on a pixel value of the class tap;
storage means for storing predictive coefficients each for predicting a target pixel from multiple pixels in a first image, said multiple pixels corresponding to a target pixel in a second image, said predictive coefficients being obtained by learning between the first and second images every class, said first image having number of pixels corresponding to the motion-blurring-mitigated image, and said second image having number of pixels more than that of the first image; and
predictive value generation means for detecting the predictive coefficients each corresponding to the class detected by the class detection means from the storage means, extracting the multiple pixels corresponding to the target pixel in the expanded image as a predictive tap from the motion-blurring-mitigated image, and generating a predictive value corresponding to the target pixel according to one-dimensional linear combination of the predictive coefficients detected from the storage means and the predictive tap.

8. A method for processing an image, said method comprising:
motion-vector-detecting step of detecting a motion vector about a moving object that moves in multiple images, each of which is made up of multiple pixels and acquired by an image sensor having time integration effects, and tracking the moving object;
motion-blurring-mitigated-object-image-generating step of generating a motion-blurring-mitigated object image in which motion blurring occurred in the moving object in each image of the multiple images is mitigated by using the motion vector detected in the motion-vector-detecting step; and
output step of combining the motion-blurring-mitigated object image that is generated in the motion-blurring-mitigated-object-image-generating step into a space-time location, in each image, corresponding to the motion vector, said motion vector being detected in the motion-vector-detecting step, to output it as a motion-blurring-mitigated image.

9. The method for processing the image according to claim 8, wherein the motion-vector-detecting step sets a target pixel corresponding to a location of the moving object in any one of at least a first image and a second image, which are sequential in terms of time, and detects a motion vector corresponding to the target pixel by using the first and second images; and
wherein the output step combines the motion-blurring-mitigated object image into a location of the target pixel in said one of the images or a location corresponding to the target pixel in the other image, said locations corresponding to the detected motion vector.

10. The method for processing the image according to claim 8, wherein in a processing region of the image, the motion-blurring-mitigated-object-image-generating step turns into a model so that a pixel value of each pixel in which no motion blurring corresponding to the moving object occur becomes a value obtained by integrating the pixel value in a time direction with the pixel being moved corresponding to the motion vector and generates a motion-blurring-mitigated object image in which motion blurring of the moving object included in the processing region is mitigated, based on the pixel value of the pixel in the processing region.

11. The method for processing the image according to claim 10, wherein the motion-blurring-mitigated-object-image-generating step includes:
region identification step of identifying a foreground region, a background region, and a mixed region in the processing region, said foreground region being composed of only a foreground object component constituting a foreground object which is moving object, said background region being composed of only a background object component constituting a background object, and said mixed region mixing the foreground object component and the background object component;
mixture-ratio-detecting step of detecting a mixture ratio of the foreground object component and the background object component in the mixed region;
separation step of separating at least a part of region of the image into the foreground object and the background object, based on the mixture ratio; and
motion-blurring-adjusting step of mitigating motion blurring of the foreground object separated in the separation step based on the motion vector.

12. The method for processing the image according to claim 10, wherein the motion-vector-detecting step detects the motion vector every pixel in the image; and
wherein the motion-blurring-mitigated-object-image-generating step sets the processing region according to the motion vector of the target pixel in the image so that the processing region includes the target pixel, and outputs pixel value in which motion blurring of the target pixel is mitigated in pixel units based on the motion vector of the target pixel.

13. The method for processing the image according to claim 8, further comprising expanded-image-generating step of generating an expanded image based on the motion-blurring-mitigated image,
wherein in the output step, the expanded image is output to a location corresponding to the motion vector in a time direction.

14. The method for processing the image according to claim 13, wherein the expanded-image-generating step includes:
class-determining step of extracting multiple pixels corresponding to a target pixel in the expanded image as a class tap from the motion-blurring-mitigated image and determining a class corresponding to the target pixel based on a pixel value of the class tap;
storing step of storing predictive coefficients each for predicting a target pixel from multiple pixels in a first image, said multiple pixels corresponding to a target pixel in a second image, said predictive coefficients being obtained by learning between the first and second images every class, said first image having number of pixels corresponding to the motion-blurring-mitigated image, and said second image having number of pixels more than that of the first image; and
predictive-value-generating step of detecting, in the storing step, the predictive coefficients each corresponding to the class detected in the class-detecting step, extracting the multiple pixels corresponding to the target pixel in the expanded image as a predictive tap from the motion-blurring-mitigated image, and generating a predictive value corresponding to the target pixel according to one-dimensional linear combination of the predictive coefficients detected in the storing step and the predictive tap

15. A program for allowing a computer to perform the following steps:
motion-vector-detecting step of detecting a motion vector about a moving object that moves in multiple images, each of which is made up of multiple pixels and acquired by an image sensor having time integration effects, and tracking the moving object;
motion-blurring-mitigated-object-image-generating step of generating a motion-blurring-mitigated object image in which motion blurring occurred in the moving object in each image of the multiple images is mitigated by using the motion vector detected in the motion-vector-detecting step; and
output step of combining the motion-blurring-mitigated object image that is generated in the motion-blurring-mitigated-object-image-generating step into a space-time location, in each image, corresponding to the motion vector, said motion vector being detected in the motion-vector-detecting step, to output it as a motion-blurring-mitigated image.
